(19) United States
(12) Patent Application Publication
(10) Pub. No.: US 2021/0308881 A1
(43) Pub. Date: Oct. 7, 2021

(54) CUTTING AND PIERCING SYSTEMS

(71) Applicant: Spellbound Development Group, Inc., Newport Beach, CA (US)

(72) Inventors: Earl Joseph Votolato, Newport Beach, CA (US); Amanda Jeanne Brooks, Santa Ana, CA (US); Ryan Michael Burkes, Huntington Beach, CA (US); Carlos David Reyes, Rancho Santa Margarita, CA (US)

(21) Appl. No.: 16/841,584

(22) Filed: Apr. 6, 2020

(51) Int. Cl. B26B 5/00; B26B 29/02; B26B 1/08

(52) U.S. Cl. CPC B26B 5/00; B26B 1/08; B26B 29/02

(57) ABSTRACT

Contemplated cutting systems are provided that include a blade, a blade holder, and a non-cutting surface. The non-cutting surface is configured to contact a surface to be cut. As the cutting system is moved across the surface and the non-cutting surface is rotated against the surface, the blade is configured to (i) pierce the surface with a first piercing edge and (ii) cut the surface with a first cutting edge. Contemplated cutting systems can be incorporated into hand or machine operated cutting tools.

### FIELD OF THE INVENTION

The field of the invention is cutting tools, and more particularly, cutting and piercing systems that can be implemented into cutting tools.

### BACKGROUND

The background description includes information that may be useful in understanding the present invention. It is not an admission that any of the information provided herein is prior art or relevant to the presently claimed invention, or that any publication specifically or implicitly referenced is prior art.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Cutting tools are used in various industries for many different purposes. For example, some industries use cutting tools, such as utility knives, to open packaging to retrieve packaged items. Users of cutting tools are typically trained to safely use such tools. Additionally, many cutting tools have safety mechanisms to further reduce the risk of injury to a user. Nonetheless, there remains a risk of injury, especially for users who use cutting tools multiple times throughout their day, and a risk that items are damaged by cutting tools in the process of unpackaging.

There have been many injuries and expenses associated cutting tools and components of cutting tools caused by, among other things, (a) loose blades, screws or other small or sharp objects contaminating food and requiring an entire batch to be thrown out, (b) loose blades, screws or other small or sharp objects contaminating food served to a customer and potentially even causing injury to customers, (c) unauthorized use by customers who have access to tools being stored in shelves or lying around a store, and (d) user injuries that occur when grabbing and replacing the blades, screws or other sharp components.

Some have contemplated a guard or shield that covers a blade or sharp surface. For example, Votolato (U.S. Pat. No. 7,475,480) discloses a knife having a blade and a shield that pivots between opened and closed position to expose or cover the blade. Others have contemplated an opening on a handle that encloses a blade or sharp surface. For example, Davis (U.S. Pat. Pub. No. 2017/0203449) discloses a knife having a blade positioned within a recess of a handle. The blade is coupled to a guide having a pointed end configured to engage a surface. Once the pointed end engages a surface, the blade is extended from the recess to thereby cut the surface.

Although efforts have been made to address safety concerns when using cutting tools, there is still a need for improved cutting tools.

### SUMMARY OF THE INVENTION

The inventive subject matter provides apparatus, systems, and methods in which a cutting system configured to pierce and cut a surface can be implemented into a cutting tool to thereby provide simple and safe methods of cutting and piercing a surface. In one aspect, a cutting system comprises a blade coupled to a blade holder. The cutting system further comprises a non-cutting surface, and the blade comprises a first cutting edge and a first piercing edge. As the cutting system is moved across a surface in a first direction, the blade is configured to (i) pierce the surface with the first piercing edge when the non-cutting surface is rotated against the surface and the blade holder is rotated to a first rotated position, and (ii) cut the surface with the first cutting edge when the blade holder is further rotated from the first rotated position to a second rotated position. It should be appreciated that contemplated cutting systems can be incorporated into hand or machine operated cutting tools.

The blade can further comprise a second cutting edge and a second piercing edge. In some embodiments, the first piercing edge and the second piercing edge are disposed on opposite ends of the blade. Additionally, the first cutting edge can be adjacent to the second piercing edge and the second cutting edge can be adjacent to the first piercing edge. It is further contemplated that as the cutting system is moved across the surface in a second direction, the blade is configured to (i) pierce the surface with the second piercing edge when the non-cutting surface is rotated against the surface and the blade holder is rotated to a third rotated position, and (ii) cut the surface with the second cutting edge when the blade holder is further rotated from the third rotated position to a fourth rotated position. Thus, in some embodiments, the cutting system can be moved in two directions (e.g., a first direction and a second direction) to pierce and cut the surface with the various cutting and piercing edges.

In some embodiments, the first piercing edge and the first cutting edge are disposed on a first half of the blade. The blade can further comprise a second cutting edge and a second piercing edge on a second half of the blade. It is contemplated that as the cutting system is moved across the surface in a second direction, the blade is configured to (i) pierce the surface with the second piercing edge when the non-cutting surface is rotated against the surface and the blade holder is rotated to a third rotated position, and (ii) cut the surface with the second cutting edge when the blade holder is further rotated from the third rotated position to a fourth rotated position.

Contemplated cutting systems can be implemented in hand or machine operated cutting tools. The blade holder can have a circular shape, semi-circular shape, U-shape, or some other shape that comprises a curved surface. For example, the blade holder can be circular-shaped and rotatably coupled to a handle. Additionally, or alternatively, the circular-shaped blade holder can be enclosed in a housing. In another example, the blade holder can have a U-shape coupled to a handle via a hinge configured to allow rotation between the handle and the blade holder.

Contemplated cutting systems can also include safety features to reduce the risk of injury to a user. For example, cutting systems can comprise a blade guard sized and dimensioned to cover the blade in a first position and uncover the blade in a second position. It is contemplated that the blade guard can comprise a flexible arm that can bend from a first position to a second position to thereby position the blade guard to uncover the blade. Additionally, or alternatively, the blade holder can comprise a cavity sized and dimensioned to receive the blade. A biasing member can be coupled to the blade to thereby bias the blade into the cavity.

In another aspect, a cutting system for a cutting device to pierce and cut a surface is contemplated. The cutting system comprises a blade having a first cutting edge and a first piercing edge. The system further comprises a non-cutting surface disposed on (i) a blade holder coupled to the blade or (ii) a blade guard configured to cover the blade. The non-cutting surface is sized and dimensioned to position (i) the first piercing edge to pierce the surface when the non-cutting surface is rotated against the surface to a first rotated position, and (ii) the first cutting edge to cut the surface when the non-cutting surface is rotated against the surface from the first rotated position to a second rotated position.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a front view of an embodiment of a cutting system.

FIGS. 2A-2D are front views of the cutting system in FIG. 1 as the cutting system is moved across or along a surface in a first direction.

FIGS. 3A-3D are front views of the cutting system in FIG. 1 as the cutting system is moved across or along a surface in a second direction.

FIG. 4 is a front view of an embodiment of a cutting tool having a cutting system.

FIG. 5 is a front view of an embodiment of a cutting tool having a cutting system.

FIG. 6 is a front view of an embodiment of a cutting system.

FIG. 7 is a front view of an embodiment of a cutting tool having a cutting system.

FIG. 8 is a front view of an embodiment of a cutting tool having a cutting system.

FIG. 9 is a front view of an embodiment of a cutting system with broken lines to show internal features of the blade.

FIGS. 10A-10C are front views of the cutting system in FIG. 9 as the cutting system is moved across a surface.

FIG. 11 is a front view of an embodiment of a cutting system with broken lines to show internal features of the blade.

FIG. 12 is a front view of an embodiment of a blade for a cutting system.

FIG. 13 is a front view of an embodiment of a blade for a cutting system.

FIG. 14 is a front view of an embodiment of a blade for a cutting system.

FIG. 15 is a front view of an embodiment of a blade for a cutting system.

FIG. 16 is a front view of an embodiment of a blade for a cutting system.

FIG. 17A is a perspective view of an embodiment of a cutting tool having a cutting system.

FIG. 17B is a bottom perspective view of the cutting tool in FIG. 17A.

FIGS. 17C-17D are perspective views of the cutting tool in FIG. 17A as it is moved across a surface.

FIG. 17E is another bottom perspective view of the cutting tool in FIG. 17A.

FIG. 17F is a top view of the cutting tool in FIG. 17A.

FIG. 17G is a cross-sectional view of the cutting tool in FIG. 17A.

FIGS. 18A-18D are front views of an embodiment of a cutting system moved across or along a surface in a first direction.

FIGS. 19A-19D are front views of the cutting system in FIGS. 18A-18D moved across or along a surface in a second direction.

FIG. 20A is a front view of an embodiment of a cutting tool having a cutting system.

FIGS. 20B-20D are front views of the cutting tool in FIG. 20A moved across a surface.

FIG. 21 is a front view of an embodiment of a cutting tool having a cutting system.

FIG. 22 is a front view of an embodiment of a cartridge for a cutting tool.

FIG. 23 is a front view of an embodiment of a cartridge for a cutting tool.

FIG. 24 is a front view of an embodiment of a cartridge for a cutting tool.

FIG. 25 is a front view of an embodiment of a cutting tool having a cutting system.

FIG. 26 is a front view of an embodiment of a cutting tool having a cutting system.

FIG. 27 is a front view of an embodiment of a cutting tool having a cutting system.

FIG. 28 is a front view of an embodiment of a cutting tool having a cutting system.

FIG. 29A is a front view of an embodiment of a cutting tool having a cutting system.

FIGS. 29B-29D are front views of the cutting tool in FIG. 29A moved across a surface.

FIG. 30 is a front view of an embodiment of a cutting tool having a cutting system.

FIG. 31 is a front view of an embodiment of a cartridge for a cutting tool.

FIG. 32 is a front view of an embodiment of a cartridge for a cutting tool.

FIG. 33 is a front view of an embodiment of a cartridge for a cutting tool.

FIG. 34 is a front view of an embodiment of a cutting tool having a cutting system.

FIG. 35 is a front view of an embodiment of a cutting tool having a cutting system.

FIG. 36 is a front view of an embodiment of a cutting tool having a cutting system.

FIG. 37 is a front view of an embodiment of a cutting tool having a cutting system.

FIG. 38 is a front view of an embodiment of a cutting tool having a cutting system.

FIG. 39A is a top perspective view of an embodiment of a cutting tool having a cutting system.

FIGS. 39B-39C are cross-sectional views of the cutting system in FIG. 39A.

FIG. 39D is a partially exploded view of the cutting system in FIG. 39A.

FIG. 39E is an exploded view of the cartridge in FIG. 39A.

FIG. 40A is a top perspective view of an embodiment of a cutting tool having a cutting system.

FIGS. 40B-40C are cross-sectional views of the cutting system in FIG. 40A.

FIGS. 41A-41B are cross-sectional views of a cutting system.

FIG. 42A is a top perspective view of an embodiment of a housing of a cutting tool.

FIG. 42B is a front perspective view of an embodiment of a blade guard of a cutting tool.

FIG. 42C is a front perspective view of an embodiment of a blade and blade holder of a cutting tool.

FIGS. 42D-42F are cross-sectional views of an embodiment of a cutting tool having the housing, blade guard, and blade shown in FIGS. 42A-42C.

FIGS. 43A-43B are top and bottom perspective views, respectively, of an embodiment of a cutting tool.

FIG. 43C is a top perspective view of the cutting tool in FIGS. 43A-43B.

FIG. 43D is a side perspective view of the cutting tool in FIGS. 43A-43B.

FIG. 43E is a front view of a cutting system of the cutting tool in FIGS. 43A-43B.

FIG. 43F is a cross-sectional view of the cutting tool in FIGS. 43A-43B.

FIG. 43G is another cross-sectional view of the cutting tool in FIGS. 43A-43B.

FIG. 43H is front perspective view of the cutting system in FIG. 43E rotating from a default position to a cutting position.

FIG. 43I is front perspective view of the cutting system in FIG. 43E rotating from a default position to another cutting position.

FIGS. 44A-44B are top and bottom perspective views, respectively, of an embodiment of a cutting tool.

FIG. 44C is a side perspective view of the cutting tool in FIGS. 44A-44B.

FIG. 44D is another side perspective view of the cutting tool in FIGS. 44A-44B.

FIG. 45A is a top perspective view of an embodiment of a cutting tool.

FIG. 45B is a bottom perspective view of the cutting tool in FIG. 45A.

FIG. 46A is a top perspective view of an embodiment of a cartridge.

FIG. 46B is a partial cross-sectional view of the cartridge in FIG. 46A.

FIG. 47A is a top perspective view of an embodiment of a cartridge.

FIG. 47B is a cross-sectional view of the cartridge in FIG. 47A.

FIG. 48A shows a top perspective view of a cutting tool.

FIG. 48B is a cross-sectional view of the cutting tool in FIG. 48A.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The subject matter described herein provides cutting systems that can be used to pierce and cut a surface in a simple and safe manner. Additionally, contemplated cutting systems comprise a blade that minimally protrudes below the surface being cut to minimize the risk of damaging items below the surface to be cut (e.g., packaged items). In some contemplated embodiments, a cutting system can comprise a blade coupled to a blade holder, and a curved surface. The blade is configured to rotate as the cutting system is moved across a surface to thereby (i) pierce the surface with a piercing edge of the blade, and (ii) cut the surface with a cutting edge of the blade. Additionally, contemplated cutting systems can comprise a blade guard that is sized and dimensioned to cover the blade in a first position and uncover the blade in a second position. Contemplated cutting systems can be incorporated into a hand or machine operated cutting tools as a permanently fixed unit or a removable unit (e.g., a cartridge that removably connects with the cutting tool).

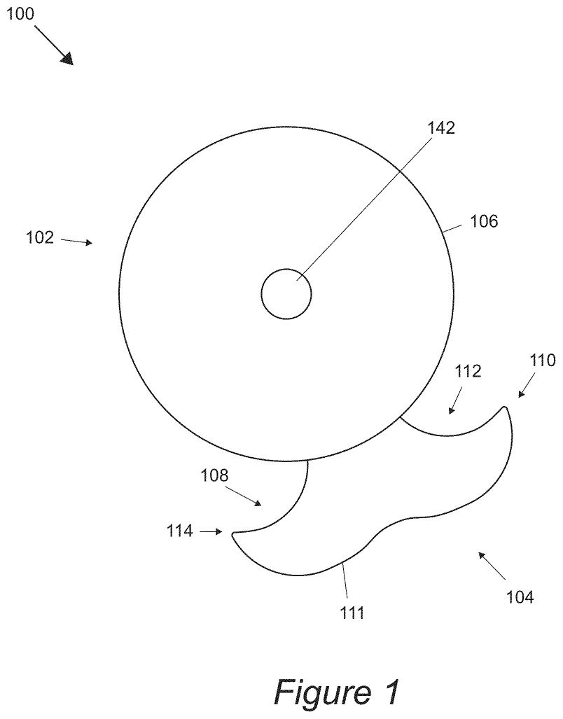

FIG. 1 shows an embodiment of a cutting system 100 configured to pierce and cut a surface. Cutting system 100 comprises a blade holder 102 and a blade 104. Blade 104 is coupled to blade holder 102. It is contemplated that blade 104 can be removably coupled to blade holder 102 using a fastener (e.g., a screw) or a snap connection (e.g., blade 104 can comprise a stem having locking arms with protrusions (i.e., a cartridge) designed to extend through slots of blade holder 102 to lock the cartridge and user can push the protrusions out of slots to thereby remove blade 104 from blade holder 102 or vice versa). Alternatively, blade 104 and blade holder 102 can be permanently coupled using an adhesive and/or providing a friction fit between a cavity of blade holder 102 and blade 104. It is further contemplated that blade holder 102 and blade 104 can be manufactured as a single component (e.g., molded to form a single component having blade holder 102 that is integrated with blade 104). It should be appreciated that cutting system 100 can be incorporated into a hand or machine operated cutting tool.

Blade holder 102 comprises a non-cutting surface 106 that is curved and configured to contact a surface to be cut. Non-cutting surface 106 is designed not to create a cut on the surface to be cut. For example, non-cutting surface 106 can be a dull or blunt surface sized and dimensioned not to create a cut on the surface to be cut. It is contemplated that non-cutting surface 106 can comprise a frictional material to create friction between non-cutting surface 106 and the surface to be cut, and thereby assist in the rotation of blade holder 102 as blade holder 102 is moved across the surface to be cut.

As shown in FIG. 1, blade holder 102 is a circular shape. The circular shape of blade holder 102 allows blade holder 102 to efficiently rotate across or along a surface to be cut. Although a circular shape is shown in FIG. 1, it is contemplated that blade holder 102 can be other shapes (e.g., a U-shape) that allow rotation of the blade holder 102 across the surface to be cut. Blade holder 102 can comprise a coupling member 142 for coupling with a hand or machine operated cutting tool. For example, coupling member 142 can comprise an opening sized and dimensioned to receive a pivot or axle of a cutting tool to thereby allow blade holder 102 to rotate with respect to the cutting tool. In another example, coupling member 142 can couple with a cutting tool in a fixed arrangement, such that blade holder 102 does not rotate with respect to the cutting tool.

Blade 104 comprises a first cutting edge 108 and a first piercing edge 110. First cutting edge 108 has a curved surface that faces in the direction of blade holder 102. It is contemplated that first cutting edge 108 can have a straight surface. First cutting edge 108 is configured to cut a surface. For example, first cutting edge 108 can be a sharp edge designed to cut a surface. First piercing edge 110 is disposed within an opposite half of blade 104 as compared to first cutting edge 108 (e.g., first cutting edge 108 is disposed within the left half of blade 104 when a vertical line is drawn down the middle of blade 104 from the perspective of FIG. 1 and first piercing edge 110 is disposed within the right half of blade 104). In other embodiments, first piercing edge 110 and first cutting edge 108 can be disposed in the same half of blade 104. First piercing edge 110 is configured to pierce a surface. For example, first piercing edge 110 can be a sharp edge designed to pierce a surface.

Blade 104 further comprises a second cutting edge 112 and a second piercing edge 114. Second cutting edge 112 has a curved surface that faces in the direction of blade holder 102. It is contemplated that second cutting edge can have a straight surface. Second cutting edge 112 is configured to cut a surface. For example, second cutting edge 112 can be a sharp edge designed to cut a surface. Second piercing edge 114 is disposed within an opposite half of blade 104 as compared to second cutting edge 112. As shown in FIG. 1, first cutting edge 108 and second piercing edge 114 can be disposed within one half of blade 104, and second cutting edge 112 and first piercing edge 110 are disposed within another half of blade 104. Thus, first cutting edge 108 is adjacent to second piercing edge 114, and second cutting edge 112 is adjacent to first piercing edge 110. Blade 104 can further comprise a third cutting edge 111 to assist in cutting a surface.

As briefly described above, cutting system 100 can be used to pierce and cut a surface. Surfaces to be cut can be corrugated and paper box products, foil, paper, plastic substrates, shrink wrap, sheetrock, plywood, and other types of surfaces. It should be appreciated that blade holder 102 and blade 104 can be made of many suitable materials (e.g., ceramic, metal, plastic, etc.) depending on the surface to be cut (e.g., thickness of surface to be cut, material of surface to be cut, etc.). For example, blade 104 can be dimensioned smaller if designed to cut thin plastic film compared to one designed to cut a double wall corrugated surface.

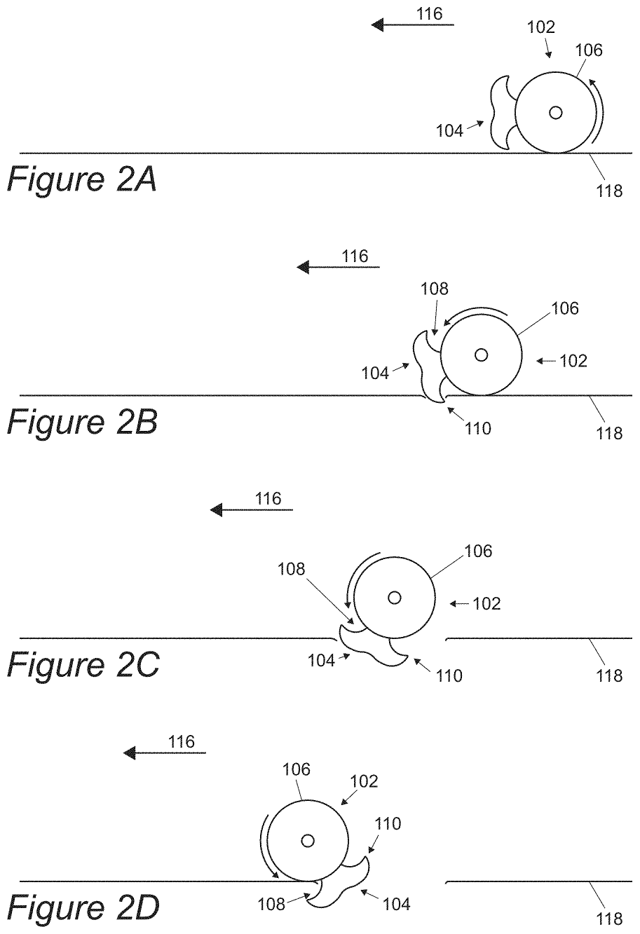

FIGS. 2A-2D show cutting system 100 being used to cut a surface 118 as it is moved in a first direction 116. It should be appreciated that cutting system 100 can form part of a hand or machine operated cutting tool. FIG. 2A shows non-cutting surface 106 against surface 118. While non-cutting surface 106 of cutting system 100 and surface 118 are in contact with one another, cutting system 100 can be moved across or along surface 118 in first direction 116 to thereby rotate blade holder 102 and blade 104 and pierce surface 118 with first piercing edge 110 (i.e., a first rotated position) as shown in FIG. 2B. Once surface 118 is pierced, cutting system 100 can be further moved in first direction 116 to further rotate blade holder 102 and blade 104 and cut surface 118 with third cutting edge 111 (see third cutting edge 111 in FIG. 1).

As cutting system 100 moves even further across or along surface 118 in first direction 116, blade holder 102 and blade 104 further rotate to thereby position first cutting edge 108 to cut surface 118 (i.e., second rotated position) as shown in FIG. 2D. Once cutting system 100 is in the position shown in FIG. 2D, cutting system 100 can be further moved in first direction 116 to further cut surface 118. It is contemplated that cutting system 100 can further comprise a stop rib or other stop mechanism to prevent further rotation and thereby maintain the position of first cutting edge 108 to further cut surface 118 along first direction 116 as shown in FIG. 2D.

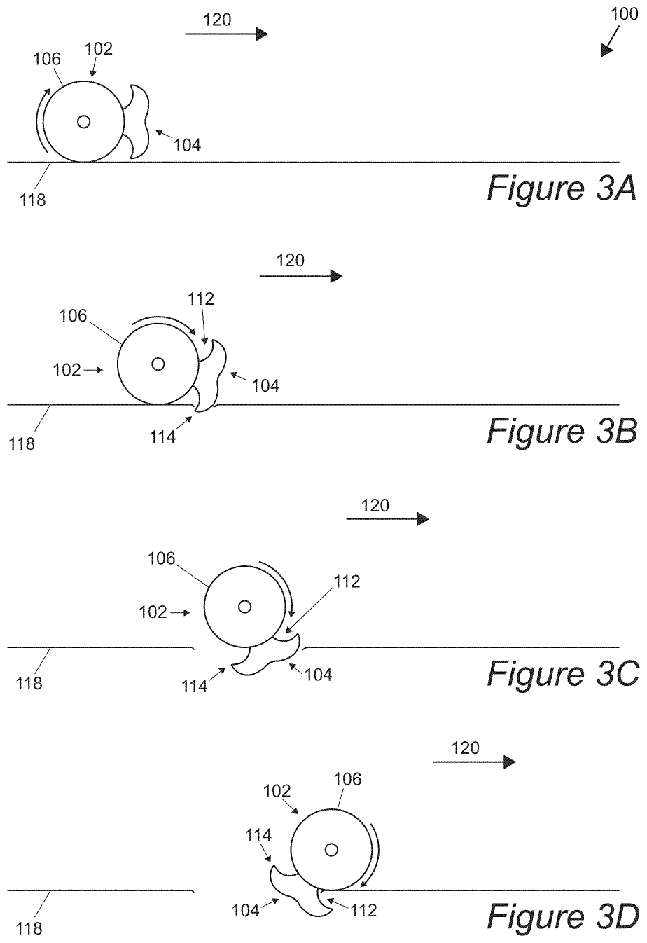

It should be appreciated that cutting system 100 can also create a cut when moved in a second direction 120 as shown in FIGS. 3A-3D. FIG. 3A shows non-cutting surface 106 against surface 118. Blade 104 is positioned on an opposite side of blade holder 102 as compared to the position of blade 104 in FIG. 2A. While non-cutting surface 106 and surface 118 are in contact with one another, cutting system 100 can be moved across surface 118 in second direction 120 to thereby rotate blade holder 102 and blade 104, and pierce surface 118 with second piercing edge 114 (i.e., a third rotated position) as shown in FIG. 3B. Once surface 118 is pierced, cutting system 100 can be further moved in second direction 120 to further rotate blade holder 102 and blade 104 and cut surface 118 with third cutting edge 111 (see third cutting edge 111 in FIG. 1).

As cutting system 100 moves even further across surface 118 in second direction 120, blade holder 102 and blade 104 further rotate to thereby position second cutting edge 112 to cut surface 118 (i.e., a fourth rotated position) as shown in FIG. 3D. Once cutting system 100 is in the position shown in FIG. 3D, cutting system 100 can be further moved across surface 118 to further cut surface 118. It is contemplated that cutting system 100 can further comprise a stop rib or other stop mechanism to prevent further rotation and thereby maintain the position of second cutting edge 112 to further cut surface 118 along second direction 120 as shown in FIG. 3D.

It should be appreciated that cutting system 100 can be used to create cuts in first direction 116 and second direction 120. When incorporated in a cutting tool, cutting system 100 can operate as described and shown to create cuts in two directions as shown and described herein. It is also contemplated that cutting system 100 can also be placed within a cutting tool to cut in a single direction.

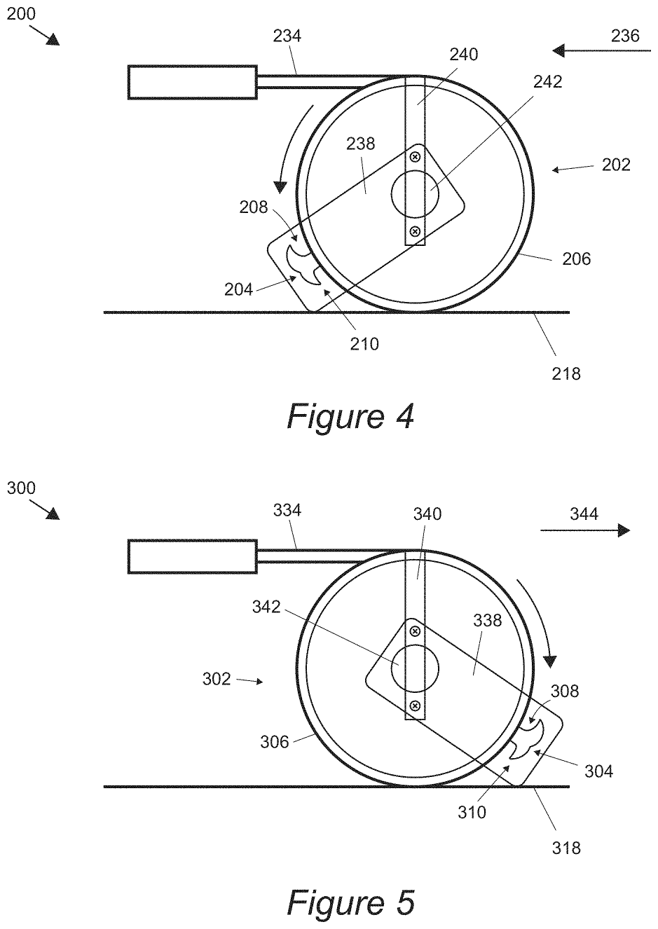

An embodiment of a cutting tool 200 for cutting a surface 218 is shown in FIG. 4. Cutting tool 200 comprises a cutting system having a blade holder 202 and a blade 204. Blade holder 202 comprises a non-cutting surface 206 that is designed not to cut surface 218. Blade 204 comprises a cutting edge 208 and a piercing edge 210. Blade 204, like blade 104 of cutting system 100, has multiple cutting and piercing edges.

Blade holder 202 is coupled to a handle 234 that can be used to move cutting tool 200 in a direction 236 across surface 218. As cutting tool 200 is moved across surface 218 in direction 236, blade holder 202 and blade 204 rotate to pierce surface 218 with piercing edge 210 and further rotate to cut surface 218 with cutting edge 208. The rotational movement of blade holder 202 and blade 204 to cut surface 218 is the same as that shown in FIGS. 2A-2D. Once rotated to a position that allows cutting edge 208 to cut surface 218, it is contemplated that such position is maintained as cutting tool 200 is moved across surface 218 in direction 236 to further cut surface 218. It is contemplated that cutting tool 200 can comprise a stop rib or a stop mechanism that prevents further rotation of blade holder 202.

Blade holder 202 can comprise a coupling member 242 that is rotatably coupled to a strut 240. As described above, blade holder 202 rotates as it is moved in direction 236. Cutting tool 200 can further comprise a blade guard 238 that covers blade 204 to prevent accidental cuts. It is contemplated that blade guard 238 is in a fixed position. Thus, blade holder 202 and blade 204 can rotate with respect to blade guard 238 to an area that is not covered by blade guard 238 to thereby pierce and cut surface 218. It is contemplated that blade guard 238 is coupled to strut 240 or another non-rotating part of cutting tool 200. Additionally, or alternatively, it is contemplated that a biasing member is coupled to blade holder 202 to thereby bias blade holder 202 to a position where blade 204 is covered or partially covered by blade guard 238 after a cut is made.

Although cutting tool 200 is discussed as moving in direction 236 to create a cut, it is contemplated that that cutting tool 200 can move in the opposite direction to create a cut. In such embodiment, blade holder 202 and blade 204 can be rotated via movement in a first or second direction to pierce and cut surface 218 as shown in FIGS. 2A-3D. It is also contemplated that blade guard 238 can be repositioned to cover blade 204 depending on the direction that cutting tool 200 will travel.

FIG. 5 shows another embodiment of a cutting tool 300. Cutting tool 300 comprises a blade holder 302, a blade 304, a coupling member 342, a blade guard 338, a handle 334, and a strut 340 as shown and described in cutting tool 200. Blade holder 302 and blade 304 are coupled to handle 334. Coupling member 342 can be rotatably coupled to strut 340 or another non-rotating part of cutting tool 300. Furthermore, cutting tool 300 can be moved across surface 318 in direction 344 to thereby pierce a surface 318 using a piercing edge 310 and cut surface 318 using cutting edge.

The rotational movement of blade holder 302 and blade 304 is the same as that shown in FIGS. 3A-3D. Once rotated to a position that allows cutting edge 308 to cut surface 318, it is contemplated that such position is maintained as cutting tool 300 is moved across surface 318 in direction 344 to further cut surface 318. It is contemplated that cutting tool 300 further comprises a stop rib or a stop mechanism that prevents further rotation of blade holder 302.

Blade guard 338 can cover blade 304 when cutting tool 300 is not being used to prevent accidental cuts. During use, blade holder 302 and blade 304 rotate relative to blade guard 338 to expose blade 304 and thereby pierce and cut surface 318. It is contemplated that cutting tool 300 can comprise a biasing member coupled to blade holder 302 to thereby bias blade holder 302 to rotate blade 304 to a position where it is covered by blade guard 338. Additionally, or alternatively, it is contemplated that blade guard 338 can be repositioned to cover blade 304 in a location different from that shown in FIG. 5.

Although cutting tool 300 is described as moving in direction 344, it is contemplated that cutting tool 300 can move in the opposite direction to create a cut. In such embodiment, blade holder 302 and blade 304 can be rotated via movement in a first or second direction to pierce and cut surface 318 as shown in FIGS. 2A-3D.

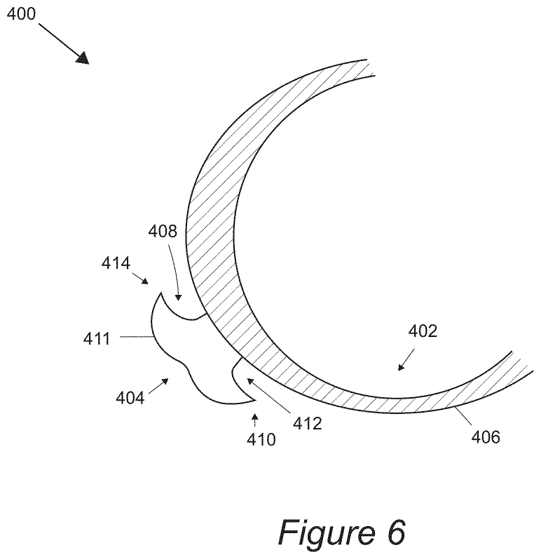

Although various examples of circular-shaped blade holders have been discussed, other shapes are contemplated. For example, FIG. 6 shows a cutting system 400 comprising a blade holder 402 having a U-shape. Cutting system 400 further comprises a blade 404 having a first cutting edge 408, a first piercing edge 410, a second cutting edge 412, a second piercing edge 414, and a third cutting edge 411. It is contemplated that the properties of blade 404 are the same as blade 104.

Blade 404 can be removably coupled to blade holder 402 using a fastener (e.g., a screw) or a snap connection (e.g., blade 404 can comprise a stem having lacking arms with protrusions designed to extend through slots of blade holder 402 or vice versa). Alternatively, blade holder 402 and blade 404 can be permanently coupled using an adhesive and/or providing a friction fit between a cavity of blade holder 402 and blade 404. In other embodiments, blade holder 402 and blade 404 can be manufactured as a single component (e.g., molded to form a single component having blade holder 402 that is integrated with blade 404). It should be appreciated that cutting system 400 can be incorporated into a hand or machine operated cutting tool.

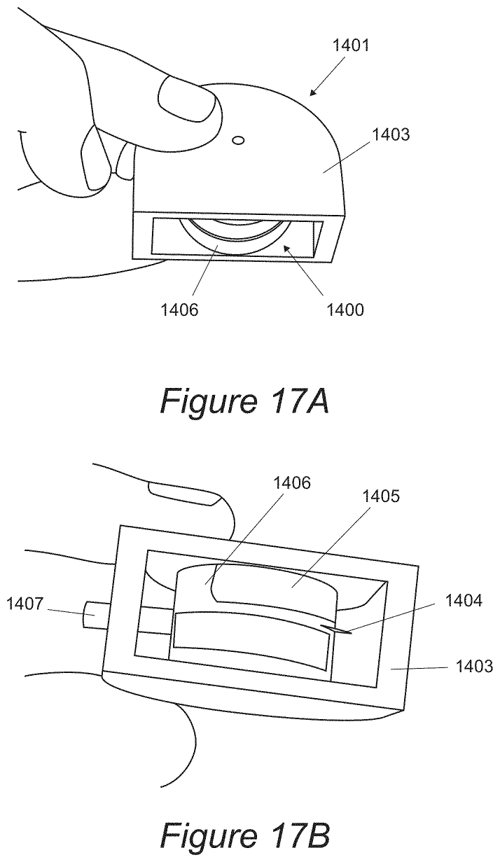

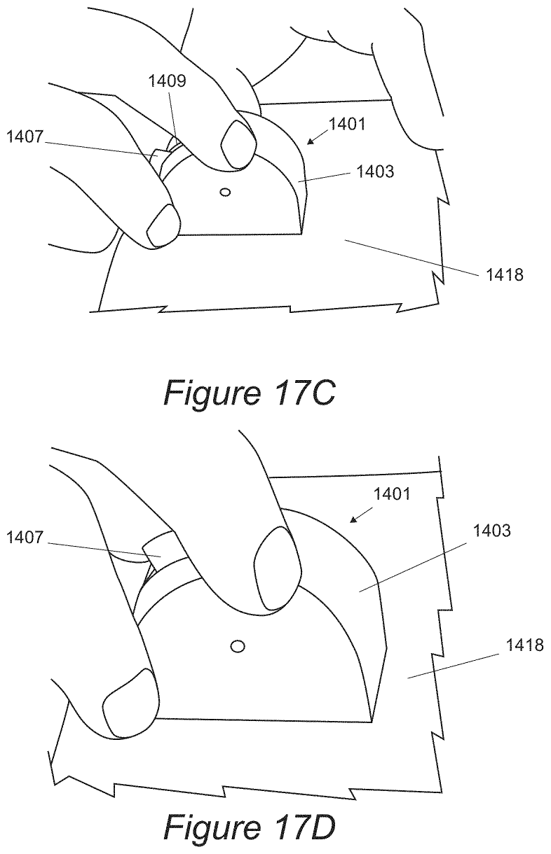

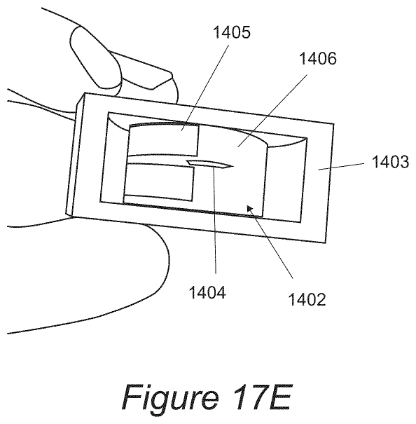

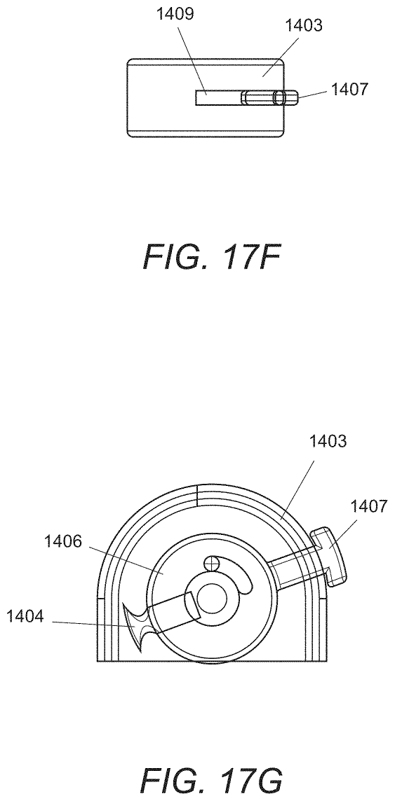

Blade holder 402 comprises a non-cutting surface 406 that is curved and designed not to create a cut on the surface to be cut. For example, non-cutting surface 406 can be a dull or blunt surface sized and dimensioned not to create a cut on the surface to be cut. Blade holder 402 can be flexible to allow blade holder 402 to flex and position blade 404 to pierce a surface using first piercing edge 410 or second piercing edge 414, and cut the surface using first cutting edge 408 or second cutting edge 412. It is contemplated that non-cutting surface 406 can comprise a frictional material to create friction between non-cutting surface 406 and the surface to be cut, and thereby help blade holder 402 flex as blade holder 402 is moved across the surface to be cut (see, e.g., frictional material 1405 in FIG. 17B). It should be noted that frictional material can be applied to non-cutting surfaces of other embodiments discussed herein.

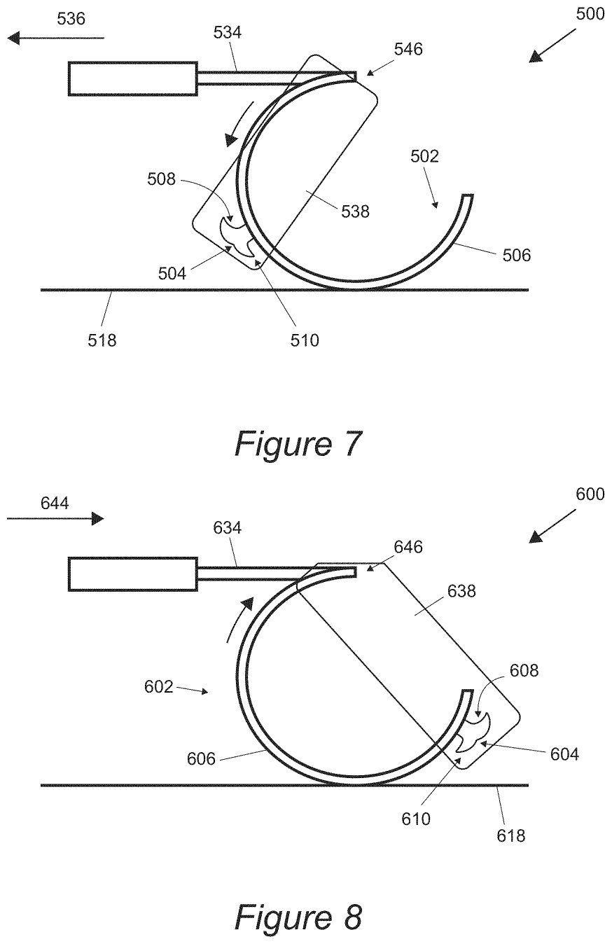

FIG. 7 shows a cutting tool 500 comprising a blade holder 502 and a blade 504. Similar to blade holder 402 and blade 404, blade holder 502 has a U-shape and blade 504 has various piercing and cutting edges. Blade holder 502 is rotatably coupled to a handle 534. For example, it is contemplated that blade holder 502 and handle 534 are coupled via a living hinge 546. Cutting tool 500 further comprises a blade guard 538 that covers blade 504 to prevent accidental cuts.

As shown in FIG. 7, a non-cutting surface 506 of blade holder 502 can be positioned to contact a surface 518. While non-cutting surface 506 and surface 518 are in contact with one another, cutting tool 500 can be moved across surface 518 in direction 536 to thereby rotate blade holder 502 and blade 504, and pierce surface 518 with piercing edge 510. Once surface 518 is pierced, cutting tool 500 can be further moved in direction 516 to further rotate blade holder 502 and blade 504 to cut surface 518 with cutting edge 508.

FIG. 8 shows a cutting tool 600 comprising a blade holder 602 and a blade 604. Cutting tool 600 has many of the same properties as cutting tool 500 including a handle 634 rotatably coupled to blade holder 602, a guard 638, blade 604 having a cutting edge 608 and a piercing edge 610, and blade holder 602 having a non-cutting surface 606. However, the position of blade 604 and guard 638 is different than the position of blade 504 and blade guard 538 of cutting tool 500 to thereby allow cutting tool 600 to cut along a direction 644.

While non-cutting surface 606 and surface 618 are in contact with one another, cutting tool 600 can be moved across surface 618 in direction 644 to thereby rotate blade holder 602 and blade 604, and pierce surface 618 with piercing edge 610. Once surface 618 is pierced, cutting tool 600 can be further moved in direction 644 to further rotate blade holder 602 and blade 604 to cut surface 618 with cutting edge 608.

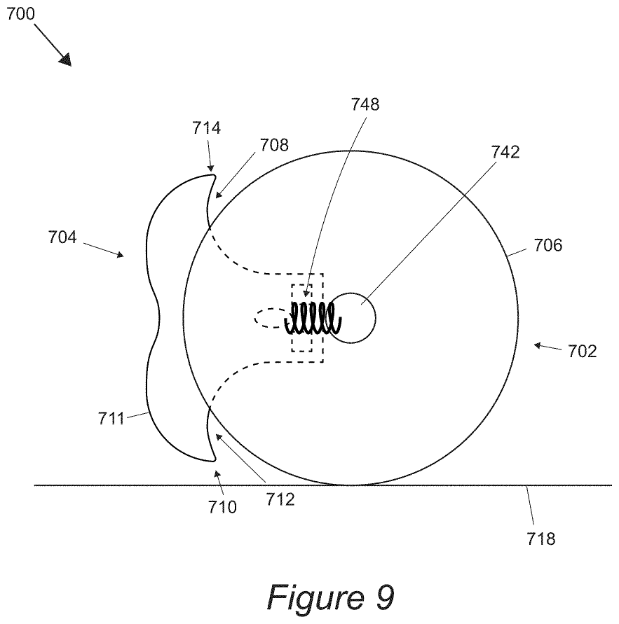

Cutting systems can comprise one or more biasing members to bias a blade holder to a default position and/or bias a blade to a position that covers at least a portion of one or more cutting edges. For example, FIG. 9 shows a cutting system 700 having a biasing member 748. Like other cutting systems described herein, cutting system 700 has a blade holder 702 and a blade 704. Blade holder 702 comprises a non-cutting surface 706 that is designed not to create a cut on a surface 718. Blade 704 comprises a first cutting edge 708, a first piercing edge 710, a second cutting edge 712, a second piercing edge 714, and a third cutting edge 711. It is contemplated that cutting system 700 can be incorporated into a hand or machine operated cutting tool. Cutting system 700 can be rotated clockwise or counterclockwise to create a cut in either direction.

As shown in FIG. 9, biasing member 748 can be a spring that is coupled to blade holder 702 and blade 704. At least a portion of blade 704 can be housed within a cavity of blade holder 702 (see, e.g., broken lines in FIG. 9 depicting portion of blade 704 housed within the cavity of blade holder 702). It is contemplated that biasing member 748 could be used to bias blade 704 into the cavity of blade holder 702 and thereby cover at least a portion of first cutting edge 708 and second cutting edge 712. In other embodiments, it is contemplated that blade 704 can be disposed within the cavity of blade holder 702 to cover first cutting edge 708, first piercing edge 710, second cutting edge 712, and second piercing edge 714. Cutting system 700 also comprises a coupling member 742 for coupling with a hand or machine operated cutting tool.

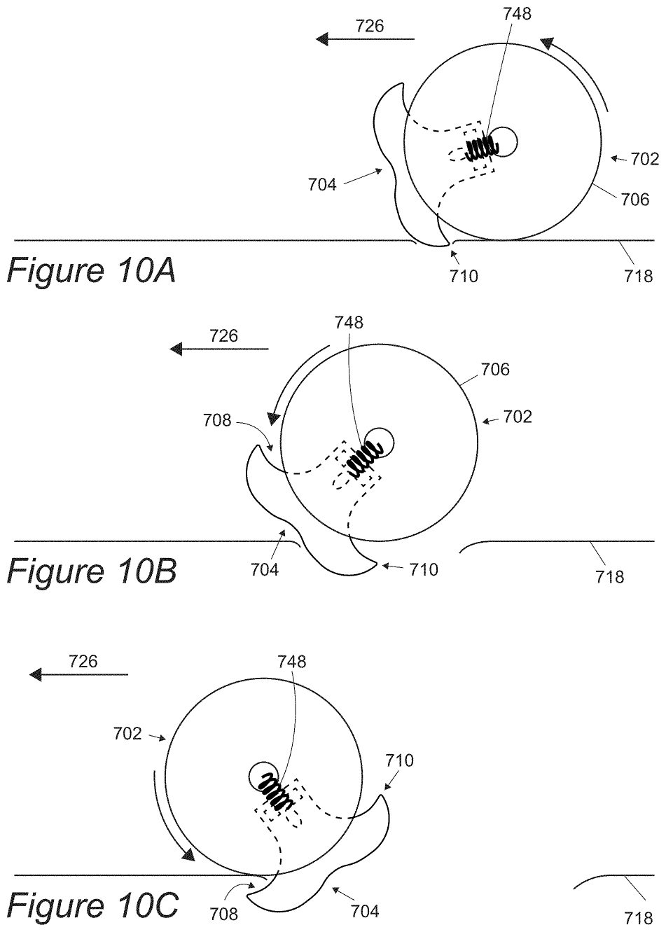

FIGS. 10A-10C show cutting system 700 being used to create a cut on surface 718 along a direction 726. While non-cutting surface 706 and surface 718 are in contact with one another, cutting system 700 (see, e.g., position in FIG. 9) can be moved across surface 718 in direction 726 to thereby rotate blade holder 702 and blade 704, and pierce surface 718 with first piercing edge 710 as shown in FIG. 10A. Once surface 718 is pierced, cutting system 700 can be further moved in direction 726 to further rotate blade holder 702 and blade 704 to cut surface 718 with third cutting edge 711 as shown in FIG. 10B. It should be appreciated that blade 704 is pulled out of the cavity of blade holder 702 as a cut is being made as shown in FIG. 10B.

As cutting system 700 moves even further across surface 718 in direction 726, blade holder 702 and blade 704 further rotate to thereby position first cutting edge 708 to cut surface 718 as shown in FIG. 10C. It should be appreciated that blade 704 is pulled out of the cavity of blade holder 702 as a cut is being made as shown in FIG. 10C. It is contemplated that cutting system 700 can further comprise a stop rib or other stop mechanism to prevent further rotation and thereby maintain the position of first cutting edge 708 as shown in FIG. 10C to further cut surface 718 along direction 726.

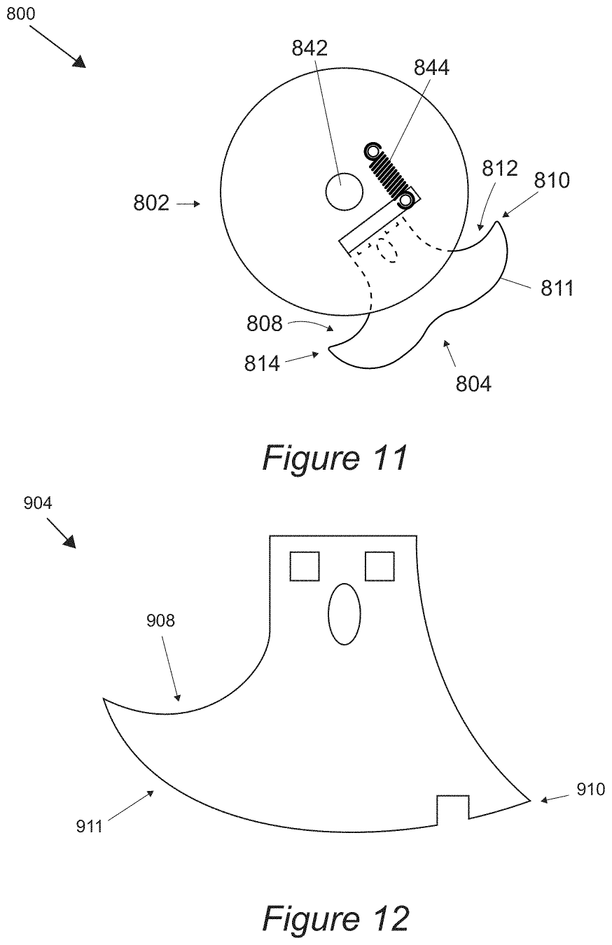

It should be appreciated that cutting system 700 can also create a cut when moved in a direction opposite of direction 726. In such embodiment, blade holder 702 and blade 704 can be rotated via movement in a first or second direction to pierce and cut surface 718. It is contemplated that biasing member 748 can be one of many springs, such as a compression spring, an extension spring, a conical spring, a coil spring, a torsion spring, and a molded sinuous spring. For example, cutting system 800 shows a biasing member 844 that is an extension spring in FIG. 11. Cutting system 800 functions the same way as cutting system 700 to pierce and cut a surface. It is contemplated that cutting system 800 can be incorporated into a hand or machine operated cutting tool. Cutting system 800 can be rotated clockwise or counterclockwise to create a cut in either direction.

Cutting system 800 comprises a blade holder 802 and a blade 804. Blade 804 comprises a first cutting edge 808, a first piercing edge 810, a second cutting edge 812, a second piercing edge 814, and a third cutting edge 811. At least a portion of blade 804 can be housed within a cavity of blade holder 802 (e.g., see broken lines in FIG. 11 depicting portion blade 804 within the cavity of blade holder 802). It is contemplated that biasing member 844 could be used to bias blade 804 into the cavity of blade holder 802 and thereby cover at least a portion of first cutting edge 808 and second cutting edge 812. In other embodiments, it is contemplated that blade 804 can be disposed within the cavity of blade holder 802 to cover first cutting edge 808, first piercing edge 810, second cutting edge 812, and second piercing edge 814. Cutting system 800 also comprises a coupling member 842 for coupling with a hand or machine operated cutting tool.

Blades can be manufactured in various shapes to pierce and cut a surface in one or two directions when mounted onto a blade holder. For example, the blades shown in FIGS. 1-11 have the same general shape with first, second and third cutting edges, and first and second piercing edges. Such blades are suitable to pierce and cut a surface in two different directions depending on whether the blade holder is rotated clockwise or counterclockwise. However, it is contemplated that a blade can be designed to create a cut in one direction. For example, FIG. 12 shows a blade 904 designed to pierce and cut a surface along one direction.

Blade 904 comprises a first cutting edge 908, a second cutting edge 911, and a piercing edge 910. Blade 904 can be mounted on a blade holder configured to rotate counterclockwise to pierce and cut a surface as shown in FIGS. 2A-2D. Thus, a surface would be pierced initially via piercing edge 910, cut via second cutting edge 911, and then further cut via first cutting edge 908. It is contemplated that blade 904 can be flipped along a vertical axis so that first cutting edge 908 is on the right side and piercing edge 910 is on the left side of blade 904. Blade 904 can be mounted in this flipped orientation onto a blade holder. In such embodiment, it is contemplated that the blade holder configured to rotate clockwise to pierce and cut a surface as shown in FIGS. 3A-3D.

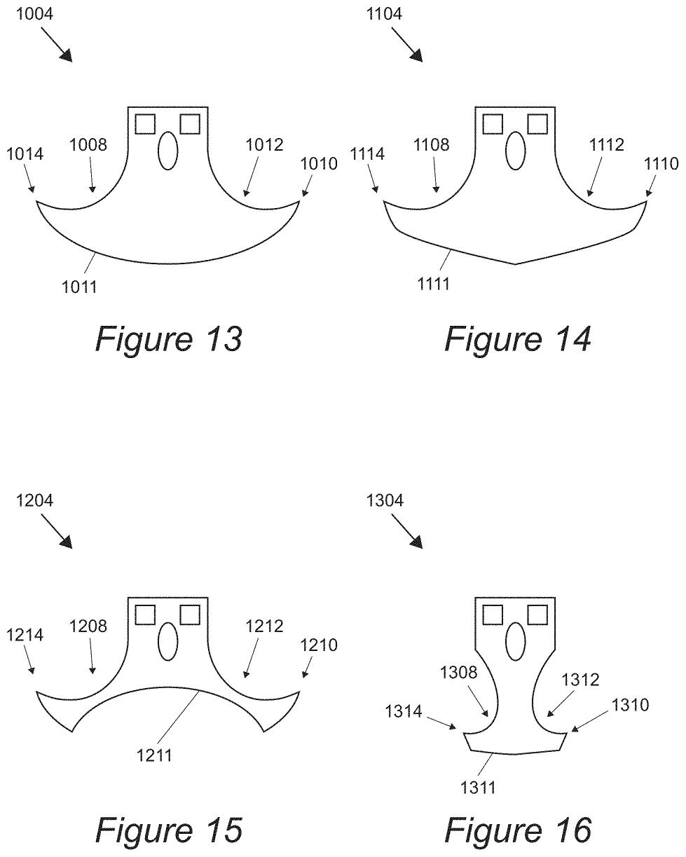

FIG. 13 shows a blade 1004 having a first cutting edge 1008, a first piercing edge 1010, a second cutting edge 1012, a second piercing edge 1014, and a third cutting edge 1011. It is contemplated that blade 1004 can pierce and cut a surface in the same manner as blade 104. Thus, blade 1004 can be mounted on a blade holder that is rotated clockwise to pierce and cut a surface using second piercing edge 1014 and second cutting edge 1012 as shown in FIGS. 3A-3D, or rotated counterclockwise to pierce and cut a surface using first piercing edge 1010 and first cutting edge 1008 as shown in FIGS. 2A-2D. Third cutting edge 1011 extends outwardly to form a “U”-shape between first piercing edge 1010 and second piercing edge 1014.

FIG. 14 shows a blade 1104 having a first cutting edge 1108, a first piercing edge 1110, a second cutting edge 1112, a second piercing edge 1114, and a third cutting edge 1111. It is contemplated that blade 1104 can pierce and cut a surface in the same manner as blade 104. Thus, blade 1104 can be mounted on a blade holder that is rotated clockwise to pierce and cut a surface using second piercing edge 1114 and second cutting edge 1112 as shown in FIGS. 3A-3D, or rotated counterclockwise to pierce and cut a surface using first piercing edge 1110 and first cutting edge 1108 as shown in FIGS. 2A-2D. Third cutting edge 1111 extends outwardly to form a “V”-shape between first piercing edge 1110 and second piercing edge 1114.

FIG. 15 shows a blade 1204 having a first cutting edge 1208, a first piercing edge 1210, a second cutting edge 1212, a second piercing edge 1214, and a third cutting edge 1211. It is contemplated that blade 1204 can pierce and cut a surface in the same manner as blade 104. Thus, blade 1204 can be mounted on a blade holder that is rotated clockwise to pierce and cut a surface using second piercing edge 1214 and second cutting edge 1212 as shown in FIGS. 3A-3D, or rotated counterclockwise to pierce and cut a surface using first piercing edge 1210 and first cutting edge 1208 as shown in FIGS. 2A-2D. Third cutting edge 1211 extends inwardly to form an inverted “U”-shape between first piercing edge 1210 and second piercing edge 1214.

FIG. 16 shows a blade 1304 having a first cutting edge 1308, a first piercing edge 1310, a second cutting edge 1312, a second piercing edge 1314, and a third cutting edge 1311. It is contemplated that blade 1304 can pierce and cut a surface in the same manner as blade 104. Thus, blade 1304 can be mounted on a blade holder that is rotated clockwise to pierce and cut a surface using second piercing edge 1314 and second cutting edge 1312 as shown in FIGS. 3A-3D, or rotated counterclockwise to pierce and cut a surface using first piercing edge 1310 and first cutting edge 1308 as shown in FIGS. 2A-2D. Third cutting edge 1311 extends slightly outwardly between first piercing edge 1310 and second piercing edge 1314.

Various cutting tools have been described having a cutting system coupled to a handle that is used to move the cutting system in a direction to thereby pierce and cut a surface. In such systems, it is contemplated that a guard can be used to cover the blade and reduce the risk of an accidental cut. However, it is also contemplated that the cutting system can be disposed within a housing. For example, FIGS. 17A-17G shows a cutting tool 1401 having a cutting system 1400 to cut a surface 1418.

Cutting tool 1401 comprises a housing 1403 that covers cutting system 1400 as shown in FIG. 17G. It is contemplated that housing 1403 has a cavity sized and dimensioned to receive cutting system 1400. Cutting system 1400 comprises a blade holder 1402 and a blade 1404. Blade holder 1402 is rotatably coupled to housing 1403.

Blade holder 1402 comprises a non-cutting surface 1406 that is designed not to create a cut on surface 1418. Non-cutting surface 1406 can comprise a frictional material 1405 to create friction between non-cutting surface 1406 and surface 1418, and thereby assist in the rotation of blade holder 1402 as cutting tool 1401 is moved across surface 1418. It is contemplated that blade 1404 can be any of the blades discussed herein (e.g., blade 104, blade 904, blade 1004, blade 1104, etc.).

The rotational movement of blade holder 1402 and blade 1404 is the same as shown in FIGS. 3A-3D. Cutting tool 1401 is placed on surface 1418 where blade holder 1402 is in contact with surface 1418 as shown in FIG. 17C. Cutting tool 1401 is then moved across surface to thereby rotate blade holder 1402 and blade 1404 to pierce surface 1418 with a piercing edge of blade 1404 (see, e.g., FIG. 3B). Blade holder 1402 and blade 1404 can further rotate as cutting tool 1401 is moved across surface 1418 to cut surface 1418 with a cutting edge of blade 1404 (see, e.g., FIG. 3C). As cutting tool 1401 is further moved across surface 1418, blade holder 1402 and blade 1404 are further rotated to cut surface 1418 with another cutting edge (see, e.g., FIG. 3D).

It is contemplated that the position of blade holder 1402 is prevented from further rotation to thereby position (see, e.g., FIG. 3D) such cutting edge to further cut surface 1418 because a stop mechanism prevents further rotation. The stop mechanism comprises a protrusion 1407 that extends through a slot 1409 of housing 1403 as shown in FIGS. 17C and 17F. Protrusion 1407 is either a portion of blade holder 1402 (i.e., protrusion 1407 and blade holder 1402 are manufactured as a single component) or protrusion 1407 can be a separate component that is coupled to blade holder 1402.

Prior to producing a pierce or a cut on surface 1418, protrusion 1407 extends through a first end of slot 1409 as shown in FIG. 17C. At this position, blade holder 1402 and blade 1404 are positioned to be subsequently rotated to thereby pierce and cut surface 1418 (see, e.g., FIG. 3A). As cutting tool 1401 is moved across surface 1418, blade holder 1402 rotates to simultaneously cause (i) blade 1404 to pierce and cut surface 1418, and (ii) protrusion 1407 to slide from the first end of slot 1409 to a second end of slot 1409. Once blade holder 1402 has rotated to position a cutting edge of blade 1404 to cut surface 1418 (see, e.g., FIG. 3D), protrusion 1417 contacts a second end of slot 1409 and is prevented from further sliding along slot 1409 as shown in FIG. 17D. As a result, blade holder 1402 is prevented from further rotation as cutting tool is moved across surface 1418.

After a cut is completed, cutting tool 1401 can be lifted from surface 1418, and protrusion 1407 can be slid back to the first end of slot 1409 to thereby return blade holder 1402 and blade 1404 to a position to produce a second pierce and cut (see, e.g., FIG. 3A). It is contemplated that a user can manually slide protrusion 1407 from the second end to the first end of slot 1409. Alternatively, it is contemplated that a biasing member can be coupled to blade holder 1402 and/or protrusion 1407 to bias blade holder 1402 and blade 1404 to a default position (see, e.g., FIG. 3A) where blade holder 1402 and blade 1404 can be subsequently rotated to thereby pierce and cut a surface.

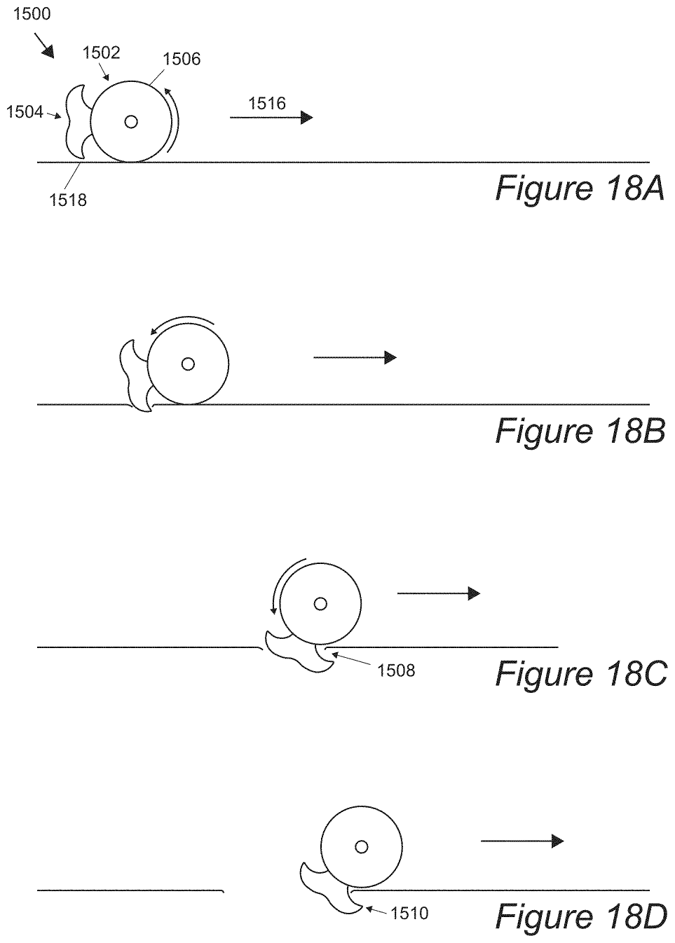

Although many embodiments described above show rotational movement of the blade holder to thereby position a piercing edge and a cutting edge in opposite halves of a blade to pierce and cut a surface, respectively, it is also contemplated that less rotational movement can be used to thereby utilize a piercing edge and a cutting edge on the same half of the blade to pierce and cut a surface, respectively. For example, FIGS. 18A-18D show a cutting system 1500 being used to cut a surface 1518 as it is moved in a first direction 1516. Similar to other cutting systems described herein, cutting system 1500 can form part of a hand or machine operated cutting tool.

FIG. 18A shows a non-cutting surface 1506 against surface 1518. While non-cutting surface 1506 of cutting system 1500 and surface 1518 are in contact with one another, cutting system 1500 can be moved across or along surface 1518 in first direction 1516 to thereby rotate blade holder 1502 and blade 1504 and pierce surface 1518 with first piercing edge 1510 (see first piercing edge 1510 in FIG. 18D) (i.e., a first rotated position) as shown in FIG. 18B. As cutting system 1500 moves even further across or along surface 1518 in first direction 1516, blade holder 1502 and blade 1504 further rotate to thereby position first cutting edge 1508 to cut surface 1518 (i.e., second rotated position) as shown in FIGS. 18C and 18D. Unlike several embodiments described above (e.g., FIGS. 2A-3D), blade holder 1502 and blade 1504 are rotated to thereby position first piercing edge 1510 and first cutting edge 1508 on the same half of the blade to pierce and cut, respectively, surface 1518. It is contemplated that cutting system 1500 can further comprise a stop rib or other stop mechanism to prevent further rotation and thereby maintain the position of first cutting edge 1508 to further cut surface 1518 along first direction 1516 as shown in FIGS. 18C and 18D.

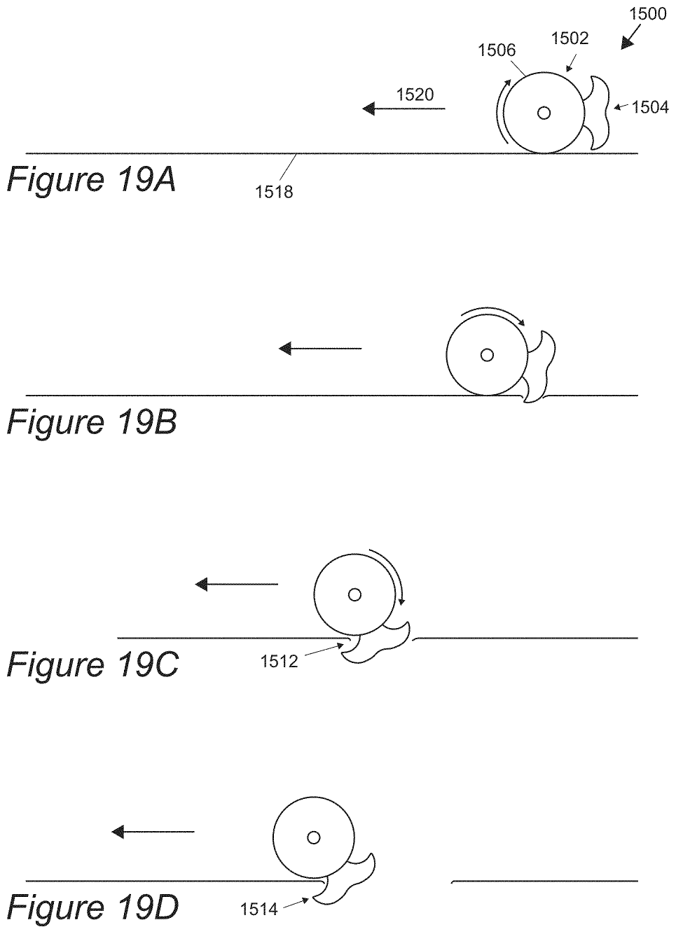

It should be appreciated that cutting system 1500 can also create a cut when moved in a second direction 1520 as shown in FIGS. 19A-19D. FIG. 19A shows non-cutting surface 1506 against surface 1518. Blade 1504 is positioned on an opposite side of blade holder 1502 as compared to the position of blade 1504 in FIG. 18A. While non-cutting surface 1506 and surface 1518 are in contact with one another, cutting system 1500 can be moved across surface 1518 in second direction 1520 to thereby rotate blade holder 1502 and blade 1504, and pierce surface 1518 with second piercing edge 1514 (i.e., a third rotated position) as shown in FIG. 19B.

As cutting system 1500 moves even further across surface 1518 in second direction 1520, blade holder 1502 and blade 1504 further rotate to thereby position second cutting edge 1512 to cut surface 1518 (i.e., a fourth rotated position) as shown in FIG. 19C. Once cutting system 1500 is in the position shown in FIG. 19C, cutting system 1500 can be further moved across surface 1518 to further cut surface 1518 as shown in FIG. 19D. It is contemplated that cutting system 1500 can further comprise a stop rib or other stop mechanism to prevent further rotation and thereby maintain the position of second cutting edge 1512 to further cut surface 1518 along second direction 1520 as shown in FIG. 19D. Unlike several embodiments described above (e.g., FIGS. 2A-3D), blade holder 1502 and blade 1504 are rotated to thereby position second piercing edge 1514 and second cutting edge 1512 on the same half of the blade to pierce and cut, respectively, surface 1518.

Furthermore, unlike several embodiments described above (e.g., FIGS. 2A-3D), blade holder 1502 rotates opposite of the direction in which cutting system 1500 is moved (e.g., blade holder 1502 rotates counterclockwise when moved to the right and clockwise when moved to the left vs. blade holder 102 rotates counterclockwise when moved to the left and clockwise when moved to the right). It is contemplated that cutting systems can comprise a device that rotates a blade holder opposite of the direction that the blade holder would rotate upon movement along or across a surface (e.g., rotate the blade holder counterclockwise when movement across a surface from left to right would cause a clockwise rotation). Additionally, or alternatively, a user can manually rotate a blade holder opposite of the direction that the blade holder would rotate upon movement along or across a surface.

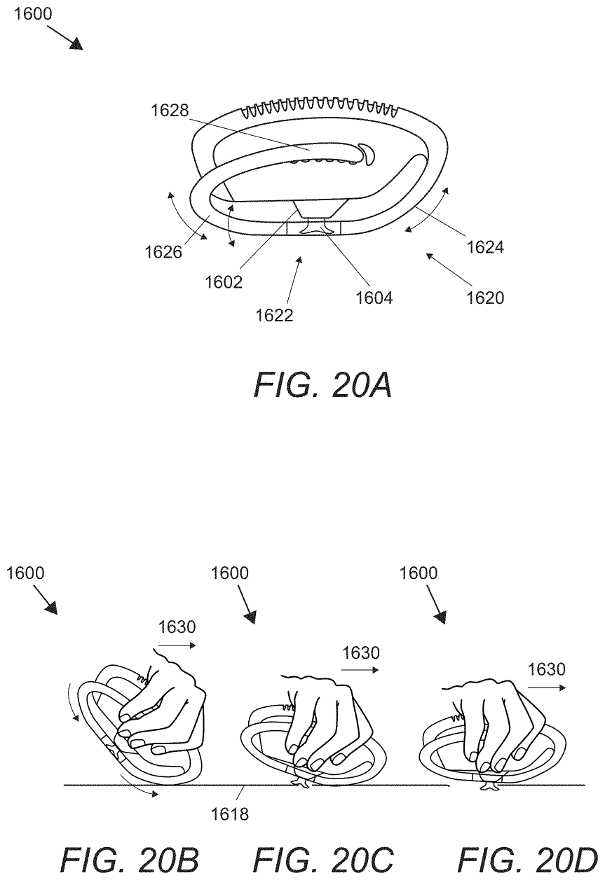

FIGS. 20A-20D show an embodiment of a hand operated cutting tool 1600. Cutting tool 1600 comprises a cutting system having a blade holder 1602 and a blade 1604. It should be appreciated that blade holder 1602 is not rotatably coupled to cutting tool 1600. Instead, cutting tool 1600 (and blade holder 1602) is rotated relative to a surface 1618 by a user to pierce and cut surface 1618 as shown in FIGS. 20B-20D. Cutting tool 1600 further comprises a flexible arm 1620 and a blade guard 1622 disposed on flexible arm 1620.

Cutting tool 1600 can be moved across or along surface 1618 in a first direction 1630 (e.g., left to right direction across a surface) to create a cut as shown in FIGS. 20B-20D. First, cutting tool 1600 is rotated by a user to position a first non-cutting surface 1624 to contact surface 1618 as shown in FIG. 20B. As shown, first non-cutting surface 1624 is disposed on flexible arm 1620. Second, first non-cutting surface 1624 is rotated against surface 1618 to thereby pierce surface 1618 with a piercing edge of blade 1604 as shown in FIG. 20C. Third, first non-cutting surface 1624 is further rotated against surface 1618 to thereby cut surface 1618 with a cutting edge of blade 1604 as shown in FIG. 20D. Cutting tool 1600 can be moved in first direction 1630 to cut surface 1618. Thus, cutting tool 1600 can be rotated counterclockwise as it is moved in first direction 1630 to pierce and cut surface 1618. It is also contemplated that cutting tool 1600 can be rotated counterclockwise prior to moving in first direction 1630 to create an initial pierce and cut of surface 1618, then cutting tool 1600 can be moved in first direction 1630.

It should be appreciated that flexible arm 1620 is configured to bend from a first position (e.g., FIGS. 20A and 20B) to a second position (e.g., FIGS. 20C and 20D) when first non-cutting surface 1624 is rotated against surface 1618. Blade guard 1622 is configured to cover blade 1604 when flexible arm 1620 is in the first position and uncover blade 1604 when flexible arm 1620 is in the second position. It is contemplated that flexible arm 1620 remains bent in the second position until a force against flexible arm 1620 (e.g., the force applied to flexible arm 1620 when first non-cutting surface 1624 is rotated against surface 1618, the force applied to flexible arm 1620 while flexible arm 1620 is pushed against surface 1618, etc.) is removed to return flexible arm 1620 to the first position. Thus, flexible arm 1620 is biased to return to the first position to thereby position blade guard 1622 to cover blade 1604 and reduce the risk that a user suffers an accidental cut.

Although a cut in first direction 1630 is shown in FIGS. 20B-20D, it is contemplated that surface 1618 can be pierced and cut in a second direction opposite of first direction (i.e., from right to left across surface 1618). In this instance, cutting tool 1600 can be rotated clockwise by a user to position a second non-cutting surface 1626 to contact surface 1618 and bend flexible arm 1620 to the second position to pierce and cut surface 1618. The clockwise rotation of cutting tool 1600 can occur (i) as cutting tool 1600 is moved in the second direction to pierce and cut surface 1618 or (i) at a first position to create an initial pierce and cut then cutting tool 1600 can be moved in the second direction to further cut surface 1618. Additionally, flexible arm 1620 comprises a handle 1628 that can be used to manually lift and bend flexible arm 1620 between the first and second positions to cover or uncover blade 1604. It is contemplated that handle 1628 can be used to (1) assist in lifting and bending flexible arm 1620 to uncover blade 1604 as flexible arm 1620 is rotated against surface 1618 or (2) lift and bend flexible arm 1620 without the need to rotate flexible arm 1620 against surface 1618 to uncover blade 1604.

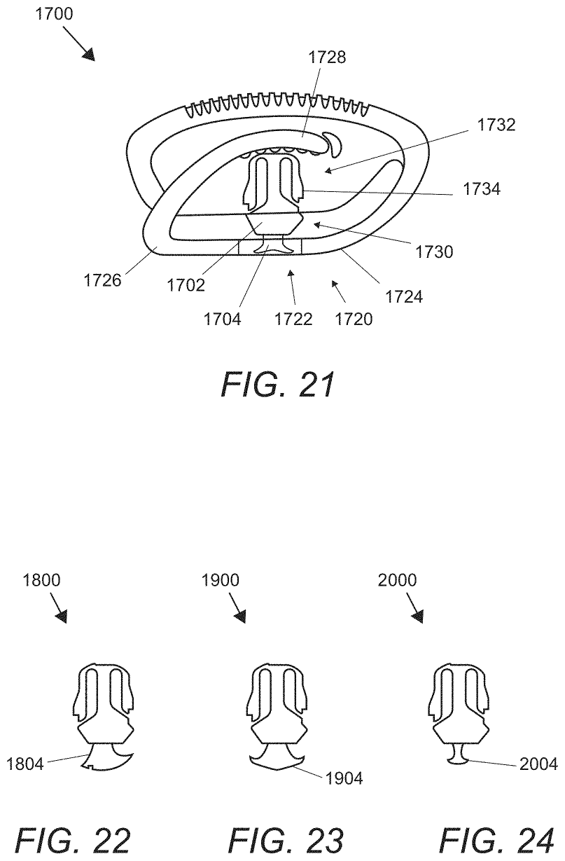

FIG. 21 shows another embodiment of a hand operated cutting tool 1700. Cutting tool 1700 comprises a cutting system having a blade holder 1702 and a blade 1704. It should be appreciated that blade holder 1702 is not rotatably coupled to cutting tool 1700. Instead, cutting tool 1700 is rotated against a surface by a user to pierce and cut the surface similar to that shown using cutting tool 1600 (see FIGS. 20B-20D).

Cutting tool 1700 comprises a first non-cutting surface 1724 and a second non-cutting surface 1726 disposed on a flexible arm 1720. Similar to that explained using cutting tool 1600, first non-cutting surface 1724 or second non-cutting surface 1726 can be rotated against a surface to bend flexible arm 1720 and move a blade guard 1722 from (i) a covered position where blade 1704 is covered to prevent a pierce or cut to (ii) an uncovered position where blade 1704 is exposed to pierce and cut the surface.

It is contemplated that flexible arm 1720 remains bent until a force against flexible arm 1720 (e.g., the force applied to flexible arm 1720 when first non-cutting surface 1724 is rotated against a surface, the force applied to flexible arm 1720 while flexible arm 1720 is pushed against a surface, etc.) is removed to return flexible arm 1720 to an unbent position where blade 1704 is covered by blade guard 1722. Additionally, flexible arm 1720 comprises a handle 1728 that can be used to manually lift and bend flexible arm 1720 between the covered and uncovered positions to cover or uncover blade 1704. It is contemplated that handle 1728 can be used to (1) assist in lifting and bending flexible arm 1720 to uncover blade 1704 as flexible arm 1720 is rotated against a surface or (2) lift and bend flexible arm 1720 without the need to rotate flexible arm 1720 against a surface to uncover blade 1704.

It should be appreciated that blade 1704 and blade holder 1702 can be part of a removable cartridge 1730 as shown in FIG. 21. Removable cartridge 1730 has a flexible spring arm 1732 that includes a locking member 1734 that extends outwardly. Locking member 1734 is sized and dimensioned to be received and locked in place by a slot within cutting tool 1700. As shown in FIG. 21, removable cartridge 1730 can have a second flexible spring arm that includes a locking member. It is contemplated that a user can squeeze flexible spring arm 1732 and the second flexible spring arm to thereby release removable cartridge 1730 from cutting tool 1700. Although use of flexible spring arms are shown in FIG. 21, removable cartridge 1730 can also be removably coupled with cutting tool 1700 using other connection types (e.g., a friction fit).

Cutting tool 1700 can be used with other types of removable cartridges. For example, removable cartridge 1800 shown in FIG. 22 can be used with cutting tool 1700. Removable cartridge 1800 comprises a blade 1804 that has a different shape than blade 1704 of removable cartridge 1730. In other examples, removable cartridge 1900 shown in FIG. 23 and removable cartridge 2000 in FIG. 24 can also be used with cutting tool 1700. Removable cartridge 1900 comprises a blade 1904 and removable cartridge 2000 also has a blade 2004 that are different from the blades of the other removable cartridges discussed herein. It should be appreciated that a user can select from various types of removable cartridges to insert into a slot of cutting tool 1700.

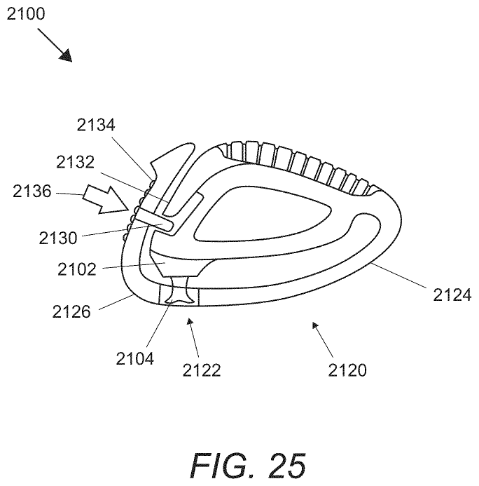

FIG. 25 shows an embodiment of another hand operated cutting tool 2100. Cutting tool 2100 comprises a cutting system having a blade holder 2102 and a blade 2104. It is contemplated that cutting tool 2100 is rotated against a surface by a user to pierce and cut a surface similar to that shown using cutting tool 1600 (see FIGS. 20B-20D).

Cutting tool 2100 comprises a first non-cutting surface 2124 and a second non-cutting surface 2126 disposed on a flexible arm 2120. As shown in FIG. 25, a blade guard 2122 can cover blade 2104 to prevent accidental cuts. Additional, or alternatively, cutting tool 2100 can comprise an additional safety feature that prevents flexible arm 2120 from bending to a position where blade guard 2122 uncovers blade 2104. Flexible arm 2120 can comprise a tab 2130 having a through hole and cutting tool 2100 can comprise a projection 2132. In its default position (see FIG. 25), the through hole of tab 2130 is not aligned with projection 2132. Thus, projection 2132 contacts a solid portion of tab 2130 to thereby limit the amount flexible arm 2120 can bend and move blade guard 2122 to uncover blade 2104.

A user can push a lever 2134 of flexible arm 2120 towards the main body of cutting tool 2100 (see direction 2136) to thereby align the through hole of tab 2130 and projection 2132. Once aligned, a user can rotate either first non-cutting surface 2124 or second non-cutting surface 2126 against a surface to bend flexible arm 2120 and move blade guard 2122 from (i) a covered position where blade 2104 is covered to prevent a pierce or cut to (ii) an uncovered position where blade 2104 is exposed to pierce and cut the surface. Since through hole of tab 2130 and projection 2132 are aligned, projection 2132 penetrates through hole of tab 2130 as flexible arm 2120 is bent to move blade guard 2122 and uncover blade 2104. As noted above, projection 2132 would otherwise contact a solid portion of tab 2130 to limit further bending of flexible arm 2120 when projection 2132 and through hole of tab 2130 are not aligned.

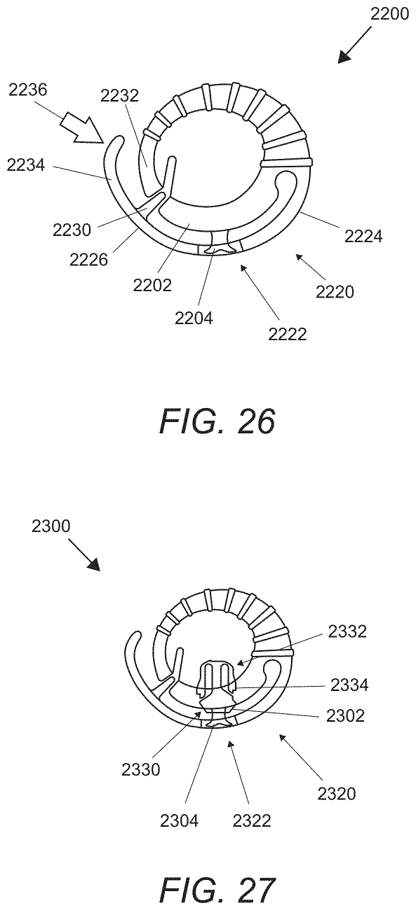

FIG. 26 shows another embodiment of a hand operated cutting tool 2200. Cutting tool 2200 comprises a cutting system having a blade holder 2202 and a blade 2204. It is contemplated that cutting tool 2200 is rotated against a surface by a user to pierce and cut a surface similar to that shown using cutting tool 1600 (see FIGS. 20B-20D).

Cutting tool 2200 comprises a first non-cutting surface 2224 and a second non-cutting surface 2226 disposed on a flexible arm 2220. As shown in FIG. 26, a blade guard 2222 can cover blade 2204 to prevent accidental cuts. Additional, or alternatively, cutting tool 2200 can comprise an additional safety feature that prevents flexible arm 2220 from bending to a position where blade guard 2222 uncovers blade 2204. Flexible arm 2220 can comprise a tab 2230 having a through hole and cutting tool 2200 can comprise a projection 2232. In its default position (see FIG. 26), the through hole of tab 2230 is not aligned with projection 2232. Thus, projection 2232 contacts a solid portion of tab 2230 to thereby limit the amount flexible arm 2220 can bend and move blade guard 2222 to uncover blade 2204.

A user can push a lever 2234 of flexible arm 2220 towards the main body of cutting tool 2200 (see direction 2236) to thereby align the through hole of tab 2230 and projection 2232. Once aligned, a user can rotate either first non-cutting surface 2224 or second non-cutting surface 2226 against a surface to bend flexible arm 2220 and move blade guard 2222 from (i) a covered position where blade 2204 is covered to prevent a pierce or cut to (ii) an uncovered position where blade 2204 is exposed to pierce and cut the surface. Since through hole of tab 2230 and projection 2232 are aligned, projection 2232 penetrates the through hole of tab 2230 as flexible arm 2220 is bent to move blade guard 2222 and uncover blade 2204. As noted above, projection 2232 would otherwise contact a solid portion of tab 2230 to limit further bending of flexible arm 2220 when projection 2232 and through hole of tab 2230 are not aligned.

FIG. 27 is another embodiment of a hand operated cutting tool 2300. It should be appreciated that cutting tool 2300 is almost identical to cutting tool 2200 (e.g., cutting tool 2300 comprises a blade holder 2302, a blade 2304, a blade guard 2322, a flexible arm 2320, a tab with a through hole, a projection, etc.). However, blade holder 2302 is part of a removable cartridge 2330.

Removable cartridge 2330 has a flexible spring arm 2332 that includes a locking member 2334 that extends outwardly. Locking member 2334 is sized and dimensioned to be received and locked in place by a slot within cutting tool 2300. As shown in FIG. 27, removable cartridge 2330 can have a second flexible spring arm that includes a locking member. It is contemplated that a user can squeeze flexible spring arm 2332 and the second flexible spring arm to thereby release removable cartridge 2330 from cutting tool 2300. Although use of flexible spring arms are shown in FIG. 27, removable cartridge 2330 can also be removably coupled with cutting tool 2300 using other connection types (e.g., a friction fit).

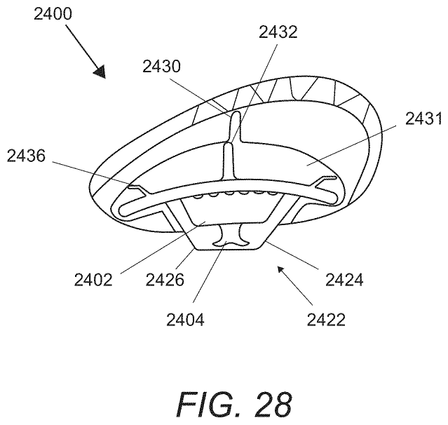

FIG. 28 shows another embodiment of a hand operated cutting tool 2400. Cutting tool 2400 comprises a cutting system having a blade holder 2402 and a blade 2404. Cutting tool 2400 further comprises a blade guard 2422 having a translucent window for a user to see blade 2404. It is contemplated that blade guard 2422 can have a transparent window for a user to see blade 2404. As shown in FIG. 28, blade guard 2422 can be partially disposed within a cavity 2431 of cutting tool 2400.

Cutting tool 2400 can comprise an additional safety feature that prevents blade guard 2422 from lifting to a position where blade guard 2422 uncovers blade 2404. Blade guard 2422 can comprise a projection 2432 that is designed to fit within a recess 2430 in cavity 2431. In its default position (see FIG. 28), recess 2430 is not aligned with projection 2432. Thus, projection 2432 contacts a solid wall within cavity 2431 to thereby limit the amount blade guard 2422 can move upwardly to uncover blade 2404.

A user can manipulate the position of blade guard 2422 (e.g., moving blade guard 2422 using a user's fingers, rotating a first non-cutting surface 2424 or a second non-cutting surface 2426 against a surface) to thereby align projection 2432 with recess 2430. Once aligned, a user can rotate either first non-cutting surface 2424 or second non-cutting surface 2426 against a surface to lift blade guard 2422 from (i) a covered position where blade 2404 is covered to prevent a pierce or cut to (ii) an uncovered position where blade 2404 is exposed to pierce and cut the surface. Since recess 2430 and projection 2432 are aligned, projection 2432 enters recess 2430 as blade guard 2422 is lifted to uncover blade 2404. As noted above, projection 2432 would otherwise contact a solid wall within cavity 2431 to prevent blade guard 2422 from uncovering blade 2404 when projection 2432 and recess 2430 are not aligned. It is contemplated that blade guard 2422 comprises a spring 2436 configured to bias blade guard 2422 to (i) cover blade 2404 and (ii) return projection 2432 to a position that is misaligned with recess 2430.

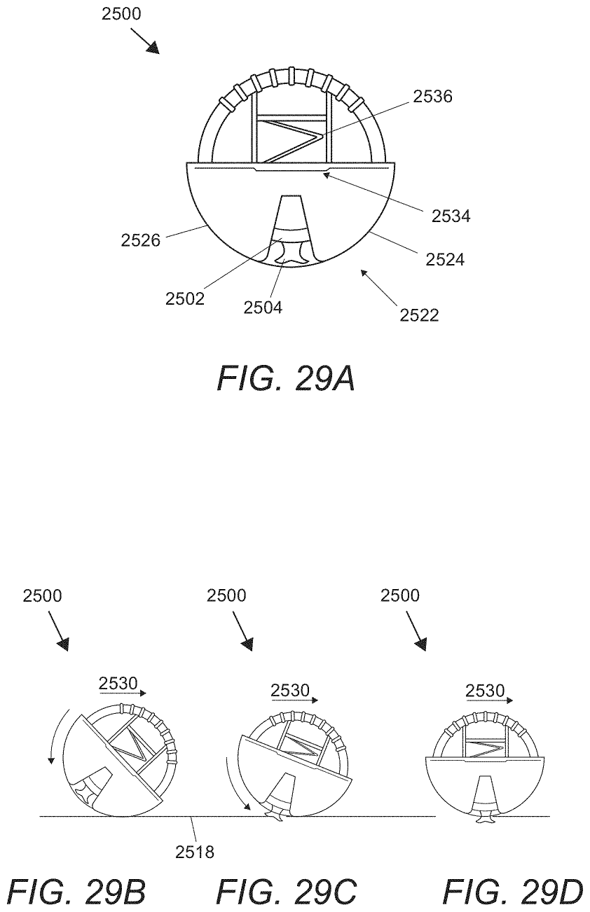

FIG. 29A shows another embodiment of a hand operated cutting tool 2500. Cutting tool 2500 comprises a cutting system having a blade holder 2502 and a blade 2504. Cutting tool 2500 further comprises a blade guard 2522 having a translucent window for a user to see blade 2504. It is contemplated that blade guard 2522 can have a transparent window for a user to see blade 2504.

Cutting tool 2500 can be moved across or along a surface 2518 in a first direction 2530 (e.g., from left to right across surface 2518) to create a cut as shown in FIGS. 29B-29D. First, cutting tool 2500 is rotated by a user to position a first non-cutting surface 2524 to contact surface 2518 as shown in FIG. 29B. As shown, first non-cutting surface 2524 is disposed on blade guard 2522. Second, first non-cutting surface 2524 is rotated against surface 2518 to thereby lift blade guard 2522 and expose blade 2504, which thereby pierces surface 2518 with a piercing edge as shown in FIG. 29C. Third, first non-cutting surface 2524 is further rotated against surface 2518 to thereby cut surface 2518 with a cutting edge of blade 2504 as shown in FIG. 29D. Cutting tool 2500 can be moved in first direction 2530 to cut surface 2518. Thus, cutting tool 2500 can be rotated counterclockwise as it is moved in first direction 2530 to pierce and cut surface 2518. It is also contemplated that cutting tool 2500 can be rotated counterclockwise prior to moving in first direction 2530 to create an initial pierce and cut of surface 2518, then cutting tool 2500 can be moved in first direction 2530.

It should be appreciated that blade guard 2522 is configured to move from a first position (e.g., FIGS. 29A and 29B) where blade 2504 is covered by blade guard 2522 to a second position (e.g., FIGS. 29C and 29D) where blade 2504 is uncovered by blade guard 2522. Blade guard 2522 can remain in the second position until a force against blade guard 2522 (e.g., the force applied to blade guard 2522 when first non-cutting surface 2524 is rotated against surface 2518, the force applied to blade guard 2522 while blade guard 2522 is pushed against surface 2518, etc.) is removed to return blade guard 2522 to the first position. As shown in FIGS. 29A-29D, a spring 2536 can be configured to bias blade guard 2522 to a first position where blade 2504 is covered.

Although a cut in first direction 2530 is shown in FIGS. 29B-29D, it is contemplated that surface 2518 can be pierced and cut in a second direction opposite of first direction (i.e., from right to left across surface 2518). In this instance, cutting tool 2500 can be rotated clockwise by a user to position a second non-cutting surface 2526 to contact surface 2518 and thereby lift blade guard 2522, and pierce and cut surface 2526 with blade 2504. The clockwise rotation of cutting tool 2500 can occur (i) as cutting tool 2500 is moved in the second direction to pierce and cut surface 2518 or (i) at a first position to create an initial pierce and cut then cutting tool 2500 can be moved in the second direction to further cut surface 2518. Additionally, blade guard 2522 can comprise a ledge 2534 that extends outwardly to provide a surface for a user's finger to manually lift blade guard 2522 to the second position and uncover blade 2504 without the need to apply a force against blade guard 2522 as discussed above.

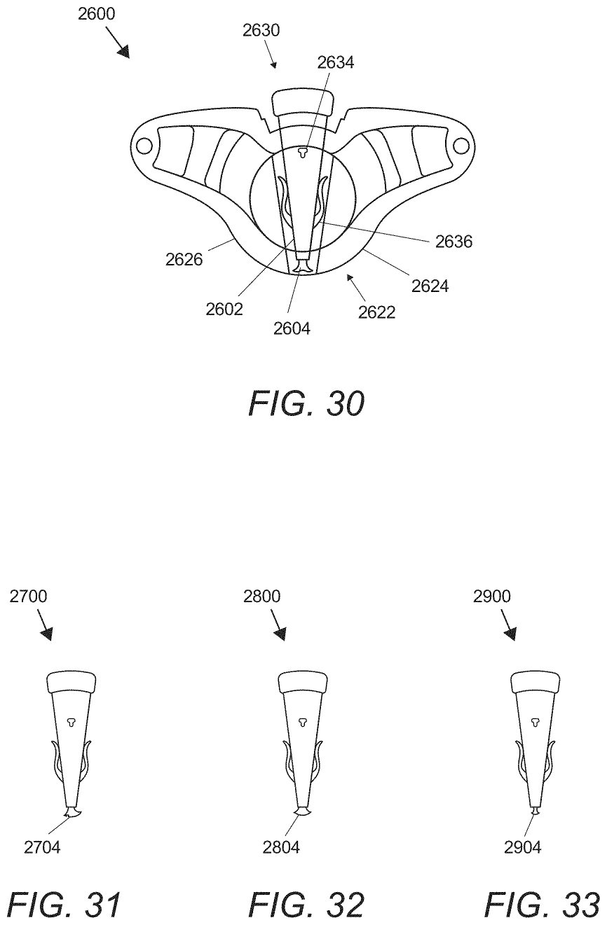

FIG. 30 shows another embodiment of a hand operated cutting tool 2600. Cutting tool 2600 comprises a cutting system having a blade holder 2602 and a blade 2604. It is contemplated that cutting tool 2600 is rotated against a surface by a user to pierce and cut the surface similar to that shown using cutting tool 2500 (see FIGS. 29B-29D).

Cutting tool 2600 comprises a blade guard 2622 having a translucent window for a user to see blade 2604. It is contemplated that blade guard 2622 can have a transparent window for a user to see blade 2604. Cutting tool 2600 comprises a first non-cutting surface 2624 and a second non-cutting surface 2626 disposed on blade guard 2622.

It should be appreciated that blade holder 2602 and blade 2604 can be part of a removable cartridge 2630. Removable cartridge 2630 has a spring arm 2636 and a second spring arm. Additionally, or alternatively, removable cartridge 2630 can comprise a locking member 2634 that projects outwardly to contact a surface of cutting tool 2600 and prevent removable cartridge 2630 from being removed from cutting tool 2600. A user can push locking member 2634 into the body of removable cartridge 2630 to thereby slide removable cartridge 2630 from cutting tool 2600.

Blade guard 2622 can remain in the covered position until a force is applied to the top of cartridge 2630 (e.g., a user pushes down on the top of cartridge 2630) to thereby cause cartridge 2630 to travel down along the angled recess of the cutting device 2600 and expose blade 2604. Once blade 2604 is exposed, first non-cutting surface 2624 or second non-cutting surface 2626 can be rotated against a surface to pierce and cut the surface (see, e.g., FIGS. 29B-29D). Once the cut is complete, the force applied to the top of cartridge 2630 can be removed to thereby allow spring arm 2636 to cause cartridge 2630 to travel up along the angled recess of cutting device 2600 to a position where blade 2604 is covered by blade guard 2622. It is contemplated that cutting tool 2600 can comprise a second spring arm that is biased to position blade 2604 to a covered position as shown in FIG. 30.

Cutting tool 2600 can be used with other types of removable cartridges. For example, removable cartridge 2700 shown in FIG. 31 can be used with cutting tool 2600. Removable cartridge 2700 comprises a blade 2704 that has a different shape compared to blade 2604. Removable cartridge 2700 further comprises spring arms and a locking member as shown in removable cartridge 2630. In other examples, removable cartridge 2800 shown in FIG. 32 and removable cartridge 2900 shown in FIG. 33 can also be used with cutting tool 2600. Removable cartridge 2800 comprises a blade 2804 and removable cartridge 2900 also has a blade 2904 that are different from the blades of the other removable cartridges discussed herein. Additionally, removable cartridge 2800 and removable cartridge 2900 comprise spring arms and a locking member as shown in removable cartridge 2630.

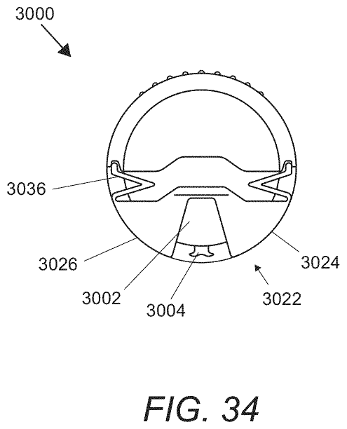

FIG. 34 shows another embodiment of a hand operated cutting tool 3000. Cutting tool 3000 comprises a cutting system having a blade holder 3002 and a blade 3004. It is contemplated that cutting tool 3000 is rotated against a surface by a user to pierce and cut the surface similar to that shown using cutting tool 2500 (see FIGS. 29B-29D).

Cutting tool 3000 comprises a blade guard 3022 having a translucent window for a user to see blade 3004. It is contemplated that blade guard 3022 can have a transparent window for a user to see blade 3004. Cutting tool 3000 comprises a first non-cutting surface 3024 and a second non-cutting surface 3026 disposed on blade guard 3022. Similar to that explained using cutting tool 2500, first non-cutting surface 3024 or second non-cutting surface 3026 can be rotated against a surface to lift blade guard 3022 from (i) a covered position where blade 3004 is covered to prevent a pierce or cut to (ii) an uncovered position where blade 3004 is exposed to pierce and cut the surface.

Blade guard 3022 can remain in the uncovered position until a force against blade guard 3022 (e.g., the force applied to blade guard 3022 when first non-cutting surface 3024 is rotated against a surface, the force applied to blade guard 3022 while blade guard 3022 is pushed against a surface, etc.) is removed to return blade guard 3022 to the covered position. As shown in FIG. 34, a spring arm 3036 can be configured to bias blade guard 3022 to the covered position. It is contemplated that cutting tool 3000 can comprise a second spring arm as shown in FIG. 34.

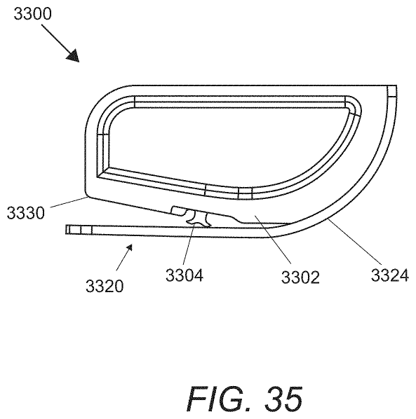

FIG. 35 shows another embodiment of a hand operated cutting tool 3300. Cutting tool 3300 comprises a cutting system having a blade holder 3302 and a blade 3304. It is contemplated that cutting tool 3300 can be rotated against a surface by a user to pierce and cut the surface similar to that shown using cutting tool 1600 (see FIGS. 20B-20D).

Cutting tool 3300 comprises a non-cutting surface 3324 disposed on a flexible arm 3320. Similar to that explained using cutting tool 1600, non-cutting surface 3324 can be rotated against a surface to bend flexible arm 3320 to allow blade 3304 to pierce and cut the surface. Unlike cutting tool 1600, which has a blade guard that covers the blade in a default position, flexible arm 3320 of cutting tool 3300 extends below blade 3304 (see FIG. 35) and acts as a physical barrier against accidental cuts. As non-cutting surface 3324 is rotated against a surface, flexible arm 3320 bends towards a bottom surface 3330 of cutting tool 3300. Blade 3304 then passes through a slot of flexible arm 3320 to extend below flexible arm 3320 to pierce and cut the surface.

Non-cutting surface 3324 can be rotated against a surface at a position that is on the left side of blade 3304 (e.g., at or near the end of flexible arm 3320) or on the right side of blade 3304 (e.g., at or near the end of the reference line for non-cutting surface 3324) to thereby bend flexible arm 3320 and create a pierce and cut using blade 3304. It is contemplated that flexible arm 3320 remains bent until a force against flexible arm 3320 (e.g., the force applied to flexible arm 3320 when non-cutting surface 3324 is rotated against a surface, the force applied to flexible arm 3320 while flexible arm 3320 is pushed against a surface, etc.) is removed to return flexible arm 3320 to an unbent position where flexible arm 3320 extends below blade 3304.

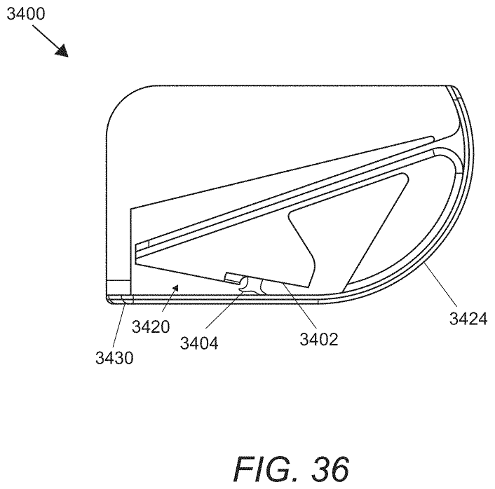

FIG. 36 shows another embodiment of a hand operated cutting tool 3400. Cutting tool 3400 comprises a cutting system having a blade holder 3402 and a blade 3404. It is contemplated that cutting tool 3400 can be rotated against a surface by a user to pierce and cut the surface similar to that shown using cutting tool 1600 (see FIGS. 20B-20D).

Cutting tool 3400 comprises blade holder 3402 and blade 3404 disposed on a flexible arm 3420. Similar to that explained using cutting tool 1600, non-cutting surface 3424 can be rotated against a surface to allow blade 3404 to pierce and cut the surface. Unlike cutting tool 1600, which has a blade guard that covers the blade in a default position, a bottom surface 3430 of cutting tool 3400 extends below blade 3404 (see FIG. 36) and acts as a physical barrier against accidental cuts.

As non-cutting surface 3424 is rotated against a surface, a user pushes down on flexible arm 3420 with one or more fingers to bend flexible arm 3420 towards bottom surface 3430 of cutting tool 3400. Blade 3404 then passes through a slot on bottom surface 3430 to extend below bottom surface 3430 to pierce and cut the surface. It is contemplated that flexible arm 3420 remains bent until a force against flexible arm 3420 (e.g., the force applied to flexible arm 3420 by user pushing down on flexible arm 3420) is removed to return flexible arm 3420 to an unbent position where bottom surface 3430 extends below blade 3404.

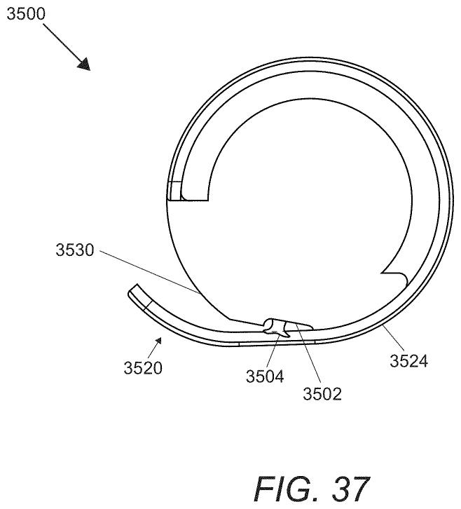

FIG. 37 shows another embodiment of a hand operated cutting tool 3500. Cutting tool 3500 comprises a cutting system having a blade holder 3502 and a blade 3504. It is contemplated that cutting tool 3500 can be rotated against a surface by a user to pierce and cut the surface similar to that shown using cutting tool 1600 (see FIGS. 20B-20D).

Cutting tool 3500 comprises a non-cutting surface 3524 disposed on a flexible arm 3520. Similar to that explained using cutting tool 1600, non-cutting surface 3524 can be rotated against a surface to bend flexible arm 3520 to allow blade 3504 to pierce and cut the surface. Unlike cutting tool 1600, which has a blade guard that covers the blade in a default position, flexible arm 3520 of cutting tool 3500 extends below blade 3504 (see FIG. 37) and acts as a physical barrier against accidental cuts. As non-cutting surface 3524 is rotated against a surface, flexible arm 3520 bends towards a bottom surface 3530 of cutting tool 3500. Blade 3504 then passes through a slot of flexible arm 3520 to extend below flexible arm 3520 to pierce and cut the surface. Additionally, or alternatively, a user can manually pull up on flexible arm 3520 to bend flexible arm 3520 upward, which thereby allows blade 3504 to pass through a slot of flexible arm 3520. It is contemplated that the user can manually pull up on flexible arm 3520 to reduce the amount of force a user would have to apply to a surface to bend flexible arm 3520 to a position where blade 3504 extends below flexible arm 3520 to pierce and cut the surface.

Non-cutting surface 3524 can be rotated against a surface at a position that is on the left side of blade 3504 (e.g., at or near the end of flexible arm 3520) or on the right side of blade 3504 (e.g., at or near the end of the reference line for non-cutting surface 3524) to thereby bend flexible arm 3520 and create a pierce and cut using blade 3504. It is contemplated that flexible arm 3520 remains bent until a force against flexible arm 3520 (e.g., the force applied to flexible arm 3520 when non-cutting surface 3524 is rotated against a surface, the force applied to flexible arm 3520 while flexible arm 3520 is pushed against a surface, etc.) is removed to return flexible arm 3520 to an unbent position where flexible arm 3520 extends below blade 3504.

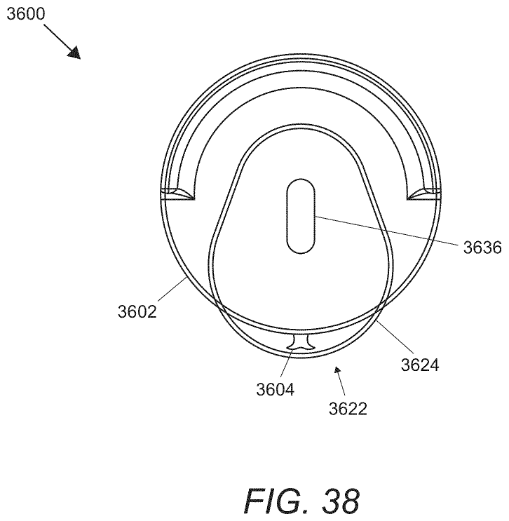

FIG. 38 shows another embodiment of a hand operated cutting tool 3600. Cutting tool 3600 comprises a cutting system having a blade holder 3602 and a blade 3604. It is contemplated that cutting tool 3600 is rotated against a surface by a user to pierce and cut the surface similar to that shown using cutting tool 2500 (see FIGS. 29B-29D).

Cutting tool 3600 comprises a blade guard 3622 having a translucent window for a user to see blade 3604. It is contemplated that blade guard 3622 can have a transparent window for a user to see blade 3604. Cutting tool 3600 comprises a non-cutting surface 3624 disposed on blade guard 3622. Similar to that explained using cutting tool 2500, non-cutting surface 3624 can be rotated against a surface. As non-cutting surface 3624 is rotated against the surface, blade guard 3622 contacts the surface to thereby cause blade guard 3622 to move from (i) a covered position where blade 3604 is covered to prevent a pierce or cut (see FIG. 38) to (ii) an uncovered position where blade 3604 is exposed to pierce and cut the surface.

Blade guard 3622 can remain in the uncovered position until a force against blade guard 3622 (e.g., the force applied to blade guard 3622 when non-cutting surface 3624 is rotated against a surface, the force applied to blade guard 3622 while blade guard 3622 is pushed against a surface, etc.) is removed to return blade guard 3622 to the covered position. As shown in FIG. 38, a slot 3636 is shown about which blade guard 3622 travels up and down to cover and uncover blade 3604. It is contemplated that a spring is disposed in slot 3636 to bias blade guard 3622 to a covered position.

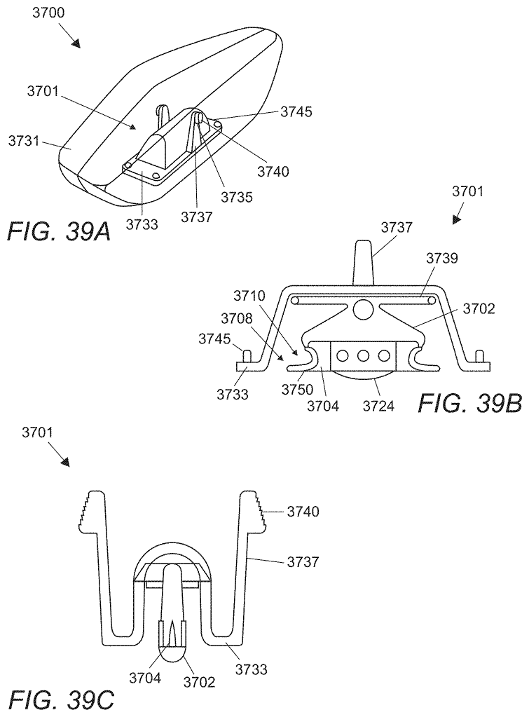

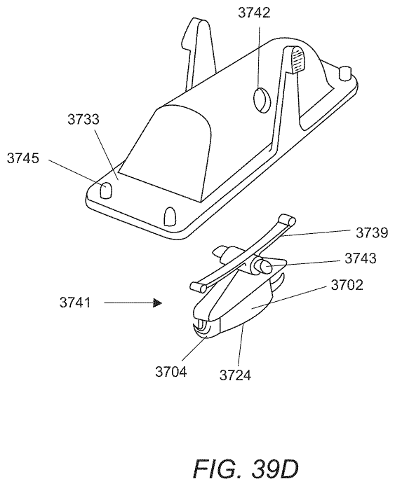

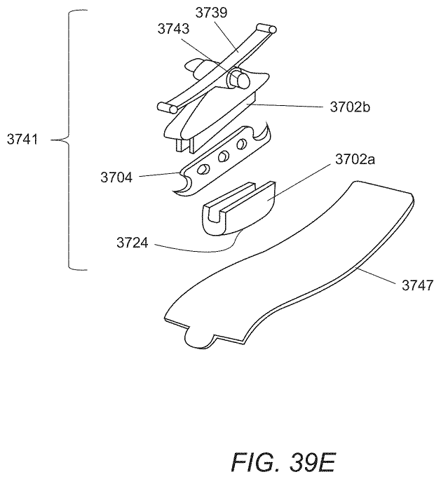

FIG. 39A shows another embodiment of a hand operated cutting tool 3700. Cutting tool 3700 comprises a housing 3731 and a cutting system 3701. It is contemplated that cutting system 3701 is removably coupled to housing 3731. Thus, cutting system 3701 can be replaced if needed by a user.

Cutting system 3701 comprises a housing 3733 having a spring arm 3737 with a locking member 3740. It is contemplated that cutting system 3701 can be slid into housing 3731 to thereby position locking member 3740 to extend through an aperture 3735 of housing 3731 and couple cutting system 3701 and housing 3731 as shown in FIG. 39A. Additionally, housing 3733 can comprise a second spring arm with a second locking member that extends through a second aperture of housing 3731. Once coupled, cutting system 3701 can be removed from housing 3731 by pushing locking member 3740 and the second locking member into the body of housing 3731 to thereby allow cutting system 3701 to slide out of housing 3731. It is contemplated that housing 3733 can comprise guide pins 3745 that slide within recesses of housing 3731 to properly position cutting system 3701 within housing 3731.

FIGS. 39B-39C show cross-sectional views of cutting system 3701. As noted above, cutting system 3701 comprises housing 3733 and spring arm 3737 with locking member 3740. Cutting system 3701 further comprises a blade 3704 and a blade holder 3702. Blade holder 3702 comprises a non-cutting surface 3724 that can be rotated against a surface to position blade 3704 to cut the surface. For example, cutting system 3701 can be (i) placed onto a surface, such that non-cutting surface 3724 is in contact with the surface, and (ii) moved across or along the surface in a first direction (e.g., from right to left across the surface) to thereby cause non-cutting surface 3724 and blade holder 3702 to rotate counterclockwise and position blade 3704 to pierce and cut the surface.

Blade 3704 comprises a non-cutting edge 3750, a piercing edge 3708, and a cutting edge 3710. It is contemplated that non-cutting edge 3750 can contact the surface to be cut as blade holder 3702 rotates counterclockwise when cutting system 3701 is moved in the first direction. As cutting system 3701 is moved further in the first direction, blade holder 3702 continues to rotate counterclockwise to position piercing edge 3708 to pierce the surface and further rotated counterclockwise to position cutting edge 3710 to cut the surface.

It is contemplated that blade 3704 can comprise a second non-cutting edge, second piercing edge, and second cutting edge as shown in FIG. 39B (see blade 3704 at opposite end of non-cutting edge 3750, piercing edge 3708, and cutting edge 3710). Cutting system 3701 can be place on a surface, such that non-cutting surface 3724 is in contact with the surface, and moved in a second direction across or along the surface (e.g., from left to right across the surface) to thereby cause non-cutting surface 3724 and blade holder 3702 to rotate clockwise and position blade 3704 to pierce and cut the surface. For example, the second non-cutting edge can contact the surface as blade holder 3702 rotates clockwise when cutting system 3701 is moved in the second direction. As cutting system 3701 is moved further in the second direction, blade holder 3702 continues to rotate clockwise to position the second piercing edge to pierce the surface and further rotated clockwise to position the second cutting edge to cut the surface. Thus, cutting tool 3700 can be moved across or along a surface in a first direction (e.g., right to left across the surface) or a second direction (e.g., left to right across the surface) to create a cut. In other words, blade holder 3702 can rotate clockwise or counterclockwise due to contact between the surface to be cut and blade holder 3702 and/or blade 3704 as cutting system 3701 is moved across or along the surface to position blade 3704 to pierce and cut the surface.

It is contemplated that blade holder 3702 contacts an inner wall of housing 3733 when blade holder 3702 rotates to a position where cutting edge 3710 or the second cutting edge cuts a surface to prevent further rotation of blade holder 3702. Once a cut is completed, a spring arm 3739 coupled to blade holder 3702 can be used to bias blade holder 3702 to a default position (e.g., the position shown in FIG. 39B). For example, spring arm 3739 can flex as blade holder 3702 is rotated clockwise or counterclockwise from a default position (e.g., the position shown in FIG. 39B) to a position where blade 3704 can create a cut, and spring arm 3739 can unflex to thereby cause blade holder 3702 to counterrotate to the default position once the cut is complete.

As discussed above, cutting system 3701 is removably coupled to housing 3731 to allow a user to replace cutting system 3701 from cutting tool 3700. Additionally, it is contemplated that blade 3704 and blade holder 3702 are removably coupled to housing 3733. FIGS. 39D-39E show a cartridge 3741 having blade 3704, blade holder 3702, and spring arm 3739. Cartridge 3741 further comprises a pin 3743 that can be inserted into an aperture 3742 of housing 3733 to removably couple cartridge 3741 and housing 3733. To decouple cartridge 3741 from housing 3733, pin 3743 can be pushed into housing 3733 to allow cartridge 3741 to slide from housing 3733.

It should be appreciated that blade 3704 of cartridge 3741 can be replaced. Blade holder 3702 can comprise a first blade holder component 3702a and a second blade holder component 3702b that coupled one another to form blade holder 3702. It is contemplated that first blade holder component 3702a is slidably coupled with second blade holder component 3702b. As shown in FIG. 39E, blade 3704 can be positioned within cavities of first blade holder component 3702a and second blade holder component 3702b. In other embodiments, blade 3704 can be permanently coupled to blade holder 3702. It is contemplated that a permanent coupling (as opposed to a removably coupling) between blade 3704 and blade holder 3702 can reduce the risk of blade 3704 becoming loose. Additionally, or alternatively, an adhesive strip 3747 (e.g., peel-away foil strip) can be placed underneath cartridge 3741 for sanitary purposes and safe handling. Adhesive strip 3747 can be removed by a user to use cutting tool 3700 and create a cut on a surface.

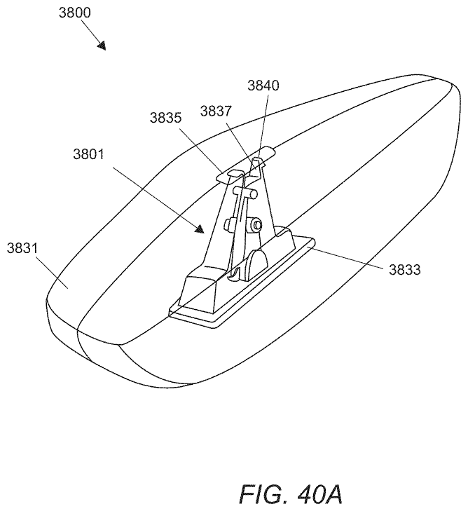

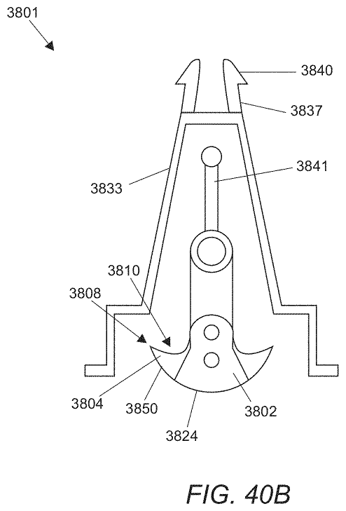

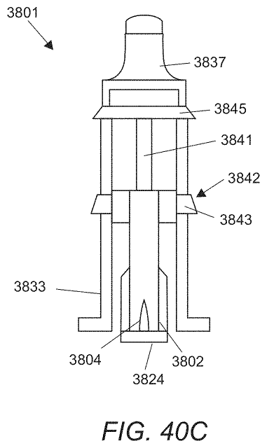

FIG. 40A shows another embodiment of a hand operated cutting tool 3800. Cutting tool 3800 comprises a housing 3831 and a cutting system 3801. It is contemplated that cutting system 3801 is removably coupled to housing 3831. Thus, cutting system 3801 can be replaced if needed by a user.

Cutting system 3801 comprises a housing 3833 having a spring arm 3837 with a locking member 3840. It is contemplated that cutting system 3801 can be slid into housing 3831 to thereby position locking member 3840 to extend through an aperture 3835 of housing 3831 and couple cutting system 3801 and housing 3831 as shown in FIG. 40A. Additionally, housing 3833 can comprise a second spring arm with a second locking member that extends through aperture 3835 of housing 3831. Once coupled, cutting system 3801 can be removed from housing 3831 by pushing locking member 3840 and the second locking member towards one another to thereby allow cutting system 3801 to slide out of housing 3833.

FIGS. 40B-40C show cross-sectional views of cutting system 3801. As noted above, cutting system 3801 comprises housing 3833 and spring arm 3837 with locking member 3840. Cutting system 3801 further comprises a blade 3804 and a blade holder 3802. Blade holder 3802 comprises a non-cutting surface 3824 that can be rotated against a surface to position blade 3804 to cut the surface. For example, cutting system 3801 can be (i) placed onto a surface, such that non-cutting surface 3824 is in contact with the surface, and (ii) moved across or along the surface in a first direction (e.g., from right to left across the surface) to thereby cause non-cutting surface 3824 and blade holder 3802 to rotate counterclockwise and position blade 3804 to cut the surface.

Blade 3804 comprises a non-cutting edge 3850, a piercing edge 3808, and a cutting edge 3810. Non-cutting edge 3805 can contact the surface as blade holder 3802 rotates counterclockwise when cutting system 3801 is moved in the first direction. It is contemplated that cutting system 3801 can be further moved in the first direction to further rotate blade holder 3802 counterclockwise to position piercing edge 3808 to pierce the surface and further rotate blade holder 3802 counterclockwise to position cutting edge 3810 to cut the surface.

It is contemplated that blade 3804 can comprise a second non-cutting edge, second piercing edge, and second cutting edge as shown in FIG. 40B (see blade 3804 at opposite end of non-cutting surface 3850, piercing edge 3808, and cutting edge 3810). Cutting system 3801 can be moved in a second direction across or along a surface (e.g. from left to right across the surface) to cause blade holder 3804 to rotate clockwise and position the second non-cutting edge to contact the surface, then position the second piercing edge to pierce the surface, and then position the second cutting edge to cut the surface. Thus, cutting tool 3800 can be moved across or along a surface in a first direction (e.g., right to left across the surface) or a second direction (e.g., left to right across the surface) to create a cut. In other words, blade holder 3802 can rotate clockwise or counterclockwise due to contact between the surface to be cut and blade holder 3802 and/or blade 3804 as cutting system 3801 is moved across or along the surface to position blade 3804 to pierce and cut the surface.

It is contemplated that blade holder 3802 contacts an inner wall of housing 3833 when blade holder 3802 rotates to a position where cutting edge 3810 or the second cutting edge cuts a surface to prevent further rotation of blade holder 3802. Once a cut is completed, a spring arm 3841 coupled to blade holder 3802 can be used to bias blade holder 3802 to a default position (e.g., the position shown in FIG. 40B). For example, spring arm 3841 can flex when blade holder 3802 is rotated from a default position (e.g., the position shown in FIG. 40B) to a position where blade 3804 can create a cut, and spring arm 3841 can unflex to thereby cause blade holder 3802 to counterrotate to the default position once the cut is complete. As shown in FIG. 40C, spring arm 3841 can comprise a locking tab 3845 that extends through slots of housing 3833 to lock spring arm 3841 within housing 3833.

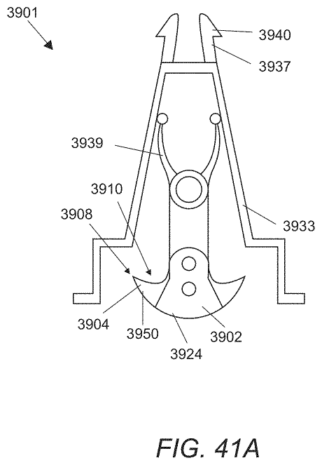

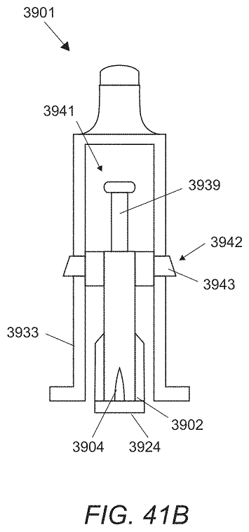

Although FIGS. 40B-40C show cutting system 3801 that can be inserted into housing 3831 of cutting tool 3800, it is contemplated that different types of cutting systems can be inserted into housing 3831 of cutting tool 3800. For example, FIGS. 41A-41B show a cutting system 3901 different than cutting system 3801. Cutting system 3901 comprises many of the same features as cutting system 3801 (e.g., a housing 3933, a spring arm 3937 with a locking member 3940, a blade 3904, a blade holder 3902, a non-cutting surface 3924 etc.).

It is contemplated that non-cutting surface 3924 can be rotated against a surface to position blade 3904 to cut the surface. For example, cutting system 3901 can be (i) placed onto a surface, such that non-cutting surface 3924 is in contact with the surface, and (ii) moved across or along the surface to thereby cause non-cutting surface 3924 and blade holder 3902 to rotate and position blade 3904 to cut the surface. Thus, cutting tool 3800 can be moved across or along a surface with cutting system 3901 disposed within housing 3831 to create a cut.

Blade 3904 comprises a non-cutting edge 3950, a piercing edge 3908, and a cutting edge 3910. Non-cutting edge 3905 can contact the surface as blade 3904 rotates, and the surface is then pierced with piercing edge 3908 and further rotated to cut with cutting edge 3910. It is contemplated that blade 3904 can comprise a second non-cutting edge, second piercing edge, and second cutting edge as shown in FIG. 41A (see blade 3904 at opposite end of non-cutting edge 3950, piercing edge 3908, and cutting edge 3910). It is contemplated that cutting tool 3800 can be moved across or along a surface in a first direction (e.g., left to right across the surface) or a second direction (e.g., right to left across the surface) to create a cut. In other words, blade holder 3902 can rotate clockwise or counterclockwise to position blade 3904 to pierce and cut the surface.

Once a cut is completed, a spring arm 3939 coupled to blade holder 3902 can be used to bias blade holder 3902 to a default position (e.g., the position shown in FIG. 41A). For example, spring arm 3939 can flex when blade holder 3902 is rotated from a default position (e.g., the position shown in FIG. 41A) to a position where blade 3904 can create a cut, and spring arm 3939 can unflex to thereby cause blade holder 3902 to counterrotate to the default position once the cut is complete. As shown in FIG. 41A, a second spring arm can be coupled to blade holder 3902 to bias blade holder 3902 to a default position (e.g., the position shown in FIG. 41A).

It is contemplated that blade 3904 and blade holder 3902 can be removably coupled to housing 3933. For example, blade 3904, blade holder 3902, and spring arm 3939 can be disposed on a cartridge 3941. Cartridge 3941 can comprise a pin 3943 that can be inserted into an aperture 3942 of housing 3933 to removably couple cartridge 3941 and housing 3933. To decouple cartridge 3941 from housing 3933, pin 3943 can be pushed into housing 3933 to allow cartridge 3941 to slide from housing 3933.

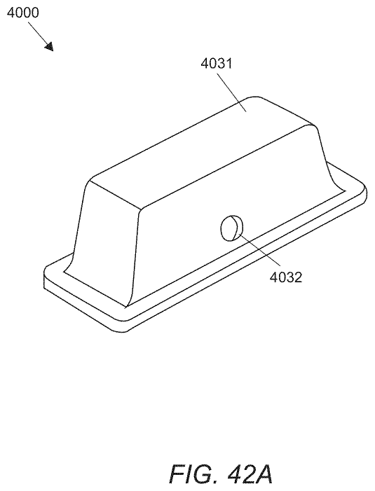

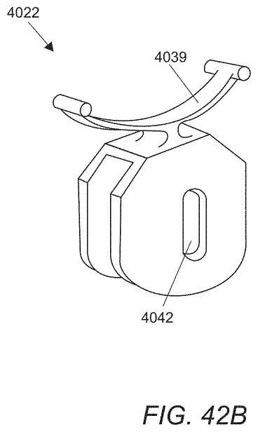

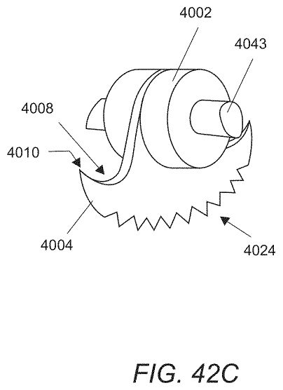

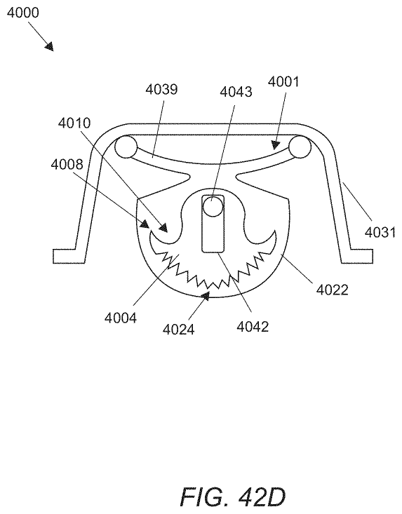

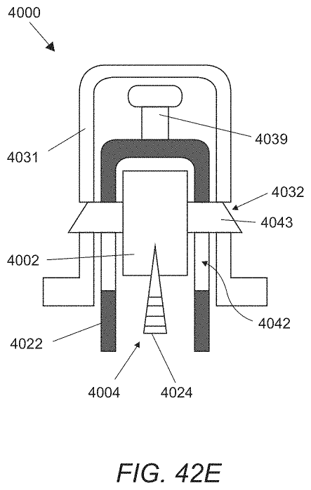

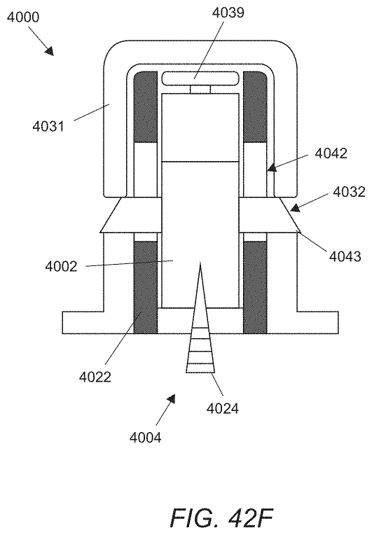

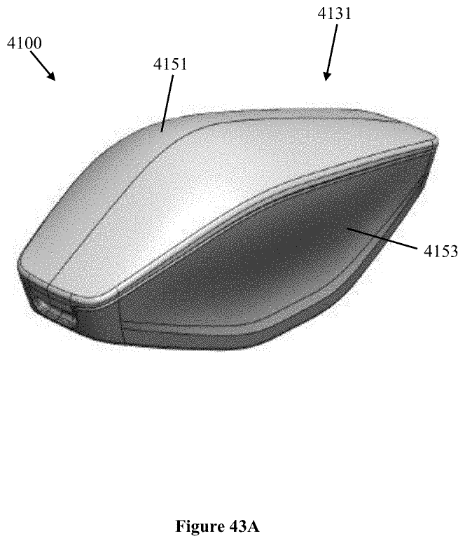

FIGS. 42A-42F show another embodiment of a hand operated cutting tool 4000. Cutting tool 4000 comprises a housing 4031 and a cutting system 4001. It is contemplated that cutting system 4001 is removably coupled to housing 4031. Thus, cutting system 4001 can be replaced if needed by a user.

It is contemplated that cutting system 4001 can be slid into housing 4031 to thereby position a pin 4043 to extend through an aperture 4032 of housing 4031 and couple cutting system 4001 and housing 4031 as shown more clearly in FIGS. 42E-42F. Additionally, cutting system 4001 can comprise a second pin that extends through a second aperture of housing 4031. Once coupled, cutting system 4001 can be removed from housing 4031 by pushing pin 4043 and the second pin into the body of housing 4031 to thereby allow cutting system 4001 to slide out of housing 4031.

Cutting system 4001 comprises a blade 4004, a blade holder 4002, and a blade guard 4022. Blade 4004 comprises a piercing edge 4010 and a cutting edge 4008. Blade 4004 further comprises a non-cutting surface 4024 that can be rotated against a surface to position piercing edge 4010 to pierce the surface and cutting edge 4008 to cut the surface. For example, cutting system 4001 can be (i) placed onto a surface, such that blade guard 4022 is lifted and non-cutting surface 4024 is in contact with the surface, and (ii) moved across or along the surface to thereby cause non-cutting surface 4024 to rotate and position blade 4004 to pierce and cut the surface.

It is contemplated that blade 4004 can comprise a second non-cutting edge, second piercing edge, and second cutting edge as shown in FIG. 42D (see blade 4004 at opposite end of piercing edge 4010 and cutting edge 4008). Cutting tool 4000 can be moved across or along a surface in a first direction (e.g., left to right across the surface) or a second direction (e.g., right to left across the surface) to create a cut. In other words, blade 4004 can rotate clockwise or counterclockwise to thereby pierce and cut the surface.

Once a cut is completed, it is contemplated that blade holder 4002 can be biased to return to a default position (e.g., the position shown in FIG. 42E). Blade guard 4022 can cover blade 4004 to reduce the risk of accidental cuts. Blade guard 4022 can comprise a spring arm 4039 and a slot 4042. When blade guard 4022 is pressed against a surface, spring arm 4039 flexes as blade guard 4022 is lifted (i.e., moves upward into housing 4031 as shown in FIG. 42F) to expose blade 4004. Once cutting tool 4000 is lifted from the surface, it is contemplated that blade guard 4022 returns to a default position (e.g., the position shown in FIG. 42E) due to the spring force provided by spring arm 4039 (i.e., spring arm 4039 unflexes to return blade guard 4022 to the default position).

As noted above, blade guard 4022 comprises slot 4042. It is contemplated that pin 4043 extends through slot 4042. Pin 4043 slides along slot 4042 when blade guard 4022 moves between positions that cover and uncover blade 4004.

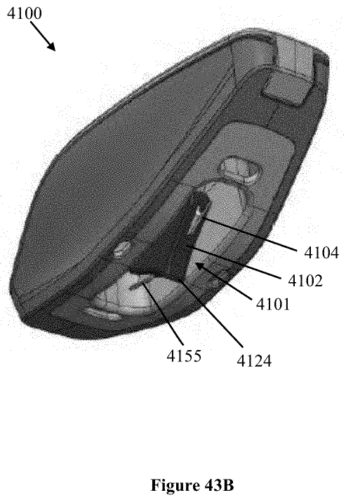

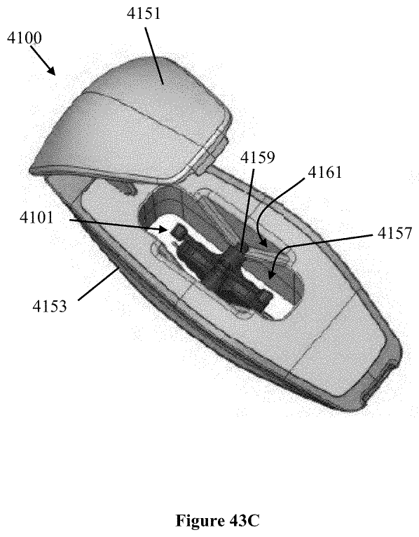

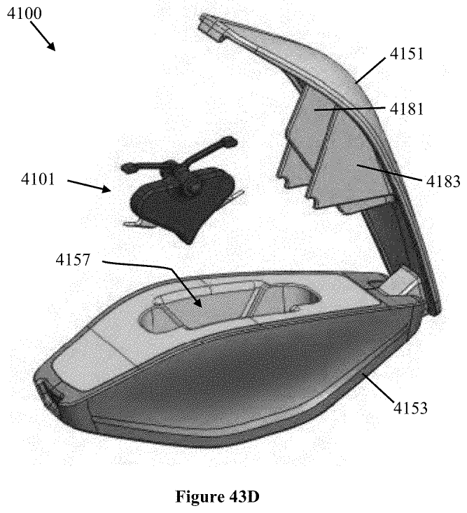

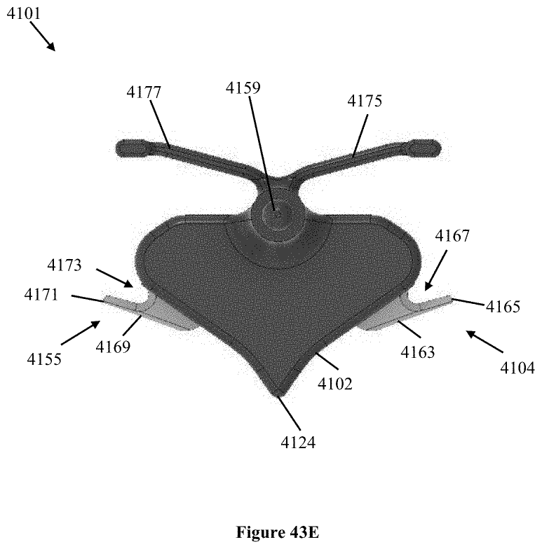

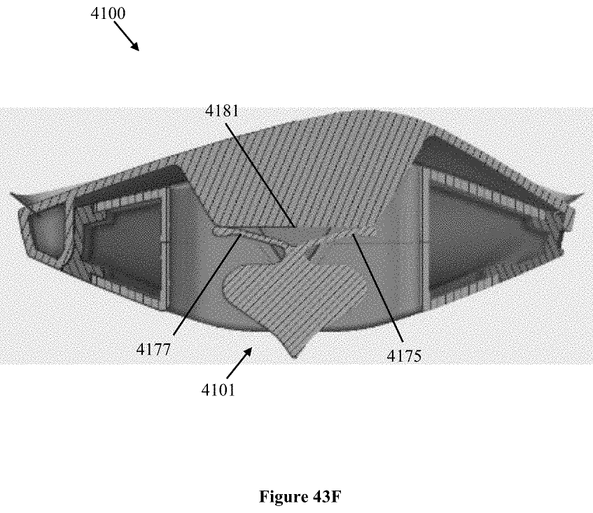

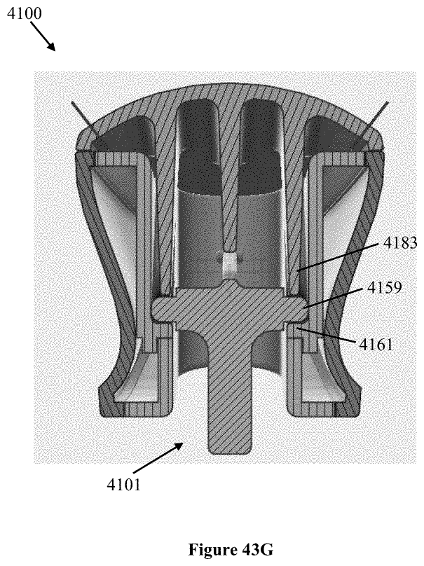

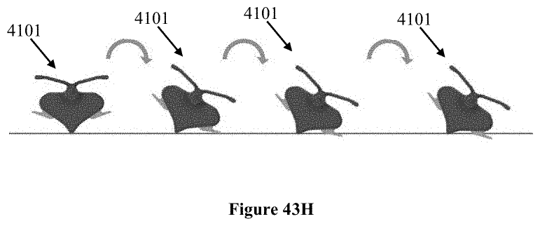

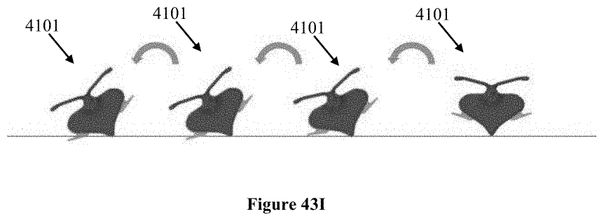

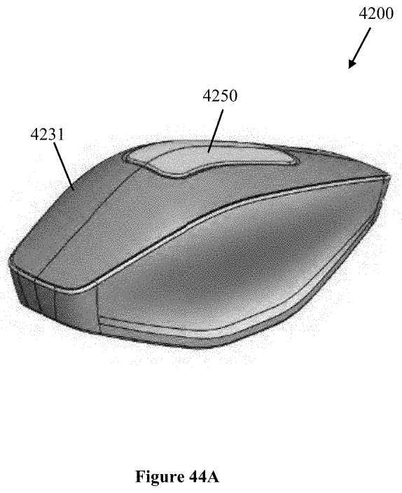

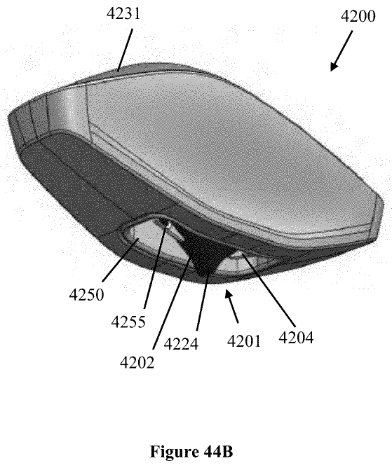

FIG. 43A shows another embodiment of a hand operated cutting tool 4100. Cutting tool 4100 comprises a housing 4131 having a top 4151 rotatably coupled to a bottom 4153. It is contemplated that cutting tool 4100 also comprises a cutting system 4101 as shown in FIG. 43B. Cutting system 4101 comprises a first blade 4104 and a second blade 4155 that are disposed on a blade holder 4102. It is contemplated that blade holder 4102 comprises a non-cutting surface 4124 that rotates against a surface to be cut to thereby position first blade 4104 or second blade 4155 to pierce and cut the surface.

FIG. 43C shows cutting tool 4100 in an opened position. Top 4151 is rotated relative to bottom 4153 to show an opening 4157. Cutting system 4101 is disposed within opening 4157 of cutting tool. As shown in FIG. 43C, cutting system 4101 can comprise a projection 4159 that rests within an angled slot 4161 within housing 4131.

It is contemplated that cutting system 4101 can be removed from housing 4131 as shown in FIG. 43D. A user can simply lift cutting system 4101 from within opening 4157. Cutting system 4101 or another cutting system can be inserted into opening 4157 and top 4151 can be rotated towards bottom 4153 to enclose cutting system 4101 or another cutting system within cutting tool 4100. As shown in FIG. 43D, top 4151 can have various surfaces that extend beneath a bottom surface of top 4151 to interact with cutting system 4101. For example, top 4151 can comprise a first protrusion 4181 that is disposed between a second protrusion 4183 and a third protrusion, whereby first protrusion 4181, second protrusion 4183, and the third protrusion are designed to interact with cutting system 4101 when disposed within housing 4131 as explained below.

In other embodiments, it is contemplated that cutting system 4101 can be loaded into cutting tool 4100 through a bottom of housing 4131, and a bottom of housing 4131 can be rotated relative to a top of housing 4131 to thereby enclose cutting system 4101 within cutting tool 4100. In yet other embodiments, it is contemplated that cutting system can be loaded into cutting tool 4100 through a rear end or front end of housing 4131, and a bottom or top of housing 4131 can be rotated relative to the other to thereby enclose cutting system 4101 within cutting tool 4100.

First blade 4104 comprises a non-cutting edge 4163, a piercing edge 4165, and a cutting edge 4167 as shown in FIG. 43E. Similarly, second blade 4155 comprises a non-cutting edge 4169, a piercing edge 4171, and a cutting edge 4173. It is contemplated that cutting tool 4100 can be moved across or along a surface in a first direction (e.g., from left to right across the surface) or a second direction (e.g., from right to left across the surface) to create a cut. In other words, blade holder 4102 can rotate clockwise or counterclockwise as cutting system 4101 is moved across or along a surface to be cut to position either first blade 4104 or second blade 4155 to pierce and cut the surface.

For example, cutting system 4101 can be (i) placed onto a surface, such that non-cutting surface 4124 is in contact with the surface as shown in FIG. 43H (see left end of FIG. 43H), and (ii) moved across or along the surface in a first direction (e.g., from left to right across the surface) to thereby cause non-cutting surface 4124 and blade holder 4102 to rotate clockwise and position first blade 4104 to have non-cutting edge 4163 contact the surface (see second from the left end in FIG. 43H). As cutting system 4101 is further moved in the first direction, blade holder 4102 continues to rotate clockwise to position piercing edge 4165 to pierce the surface (see third from the left end in FIG. 43H), and is further rotated to thereby position cutting edge 4167 to cut the surface (see right end in FIG. 43H). Once cutting edge 4167 is positioned to cut the surface, it is contemplated that further rotation is prevented due to (i) contact between blade holder 4102 and an inner surface of housing 4131 or a spring arm of blade holder 4102 that is pressed against an inner surface of housing 4131 and/or (ii) a spring force caused by a spring arm of blade holder 4102 when the spring arm is flexed to a pre-determined position.

In such example, cutting system 4101 could be moved in a second direction across or along a surface (e.g., from right to left across the surface) as shown in FIG. 43I to position second blade 4155 to cut and pierce the surface. Cutting system 4101 can be placed onto a surface, such that non-cutting surface 4124 is in contact with the surface (see right end of FIG. 43I), and moved across the surface in the second direction to cause non-cutting surface 4124 and blade holder 4102 to rotate counterclockwise and position second blade 4155 to have non-cutting edge 4169 contact the surface (see second from the right end of FIG. 43I). As cutting system 4101 is further moved in the second direction, blade holder 4102 continues to rotate counterclockwise to position piercing edge 4171 to pierce the surface (see third from the right end of FIG. 43I), and is further rotated to thereby position cutting edge 4173 to cut the surface (see left end in FIG. 43I). Once cutting edge 4173 is positioned to cut the surface, it is contemplated that further rotation is prevented due to (i) contact between blade holder 4102 and an inner surface of housing 4131 or a spring arm of blade holder 4102 that is pressed against an inner surface of housing 4131 and/or (ii) a spring force caused by a spring arm of blade holder 4102 when the spring arm is flexed to a pre-determined position.

Once a cut is completed, a first spring arm 4175 or a second spring arm 4177 can be used to bias blade holder 4102 to a default position (e.g., the position shown in FIG. 43B). For example, first spring arm 4175 or second spring arm 4177 can flex when pushed against first protrusion 4181 as blade holder 3702 is rotated clockwise or counterclockwise from a default position (e.g., the position shown in FIG. 43B). FIG. 43F shows that first spring arm 4175 and second spring arm 4177 can contact first protrusion 4181 when cutting system 4101 is disposed within housing 4131. As blade holder 4102 rotates clockwise, second spring arm 4177 pushes against first protrusion 4181 and is caused to flex. Once a cut is completed, second spring arm 4177 unflexes to counterrotate blade holder 4102 to the default position (e.g., the position shown in FIG. 43F). Similarly, as blade holder 4102 rotates counterclockwise, first spring arm 4175 pushes against first protrusion 4181 and is caused to flex. Once a cut is completed, first spring arm 4175 unflexes to counterrotate blade holder 4102 to the default position (e.g., the position shown in FIG. 43F).

When cutting system 4101 is disposed within housing 4131, it should be noted that projection 4159 is held within angled slot 4161 by second protrusion 4183 as shown in FIG. 43G. It is contemplated that cutting system 4101 can have a second projection that rests within a second angled slot, and the second projection is held within the second angled slot by the third projection of top 4151 as shown in FIG. 43G (see the second projection of blade holder 4102 that extends on the opposite side of blade holder 4102 from projection 4159 in FIG. 43G). It is further contemplated that projection 4159 and the second projection of blade holder act as a pivot about which blade holder 4102 rotates to position first blade 4104 and second blade 4155 to pierce and cut a surface.

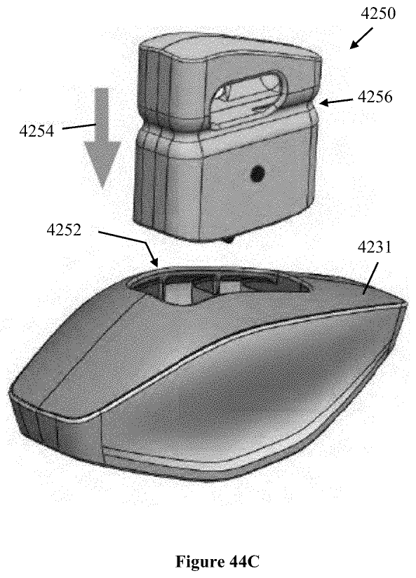

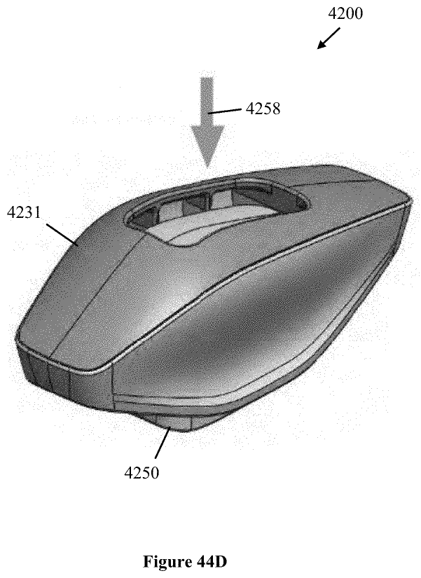

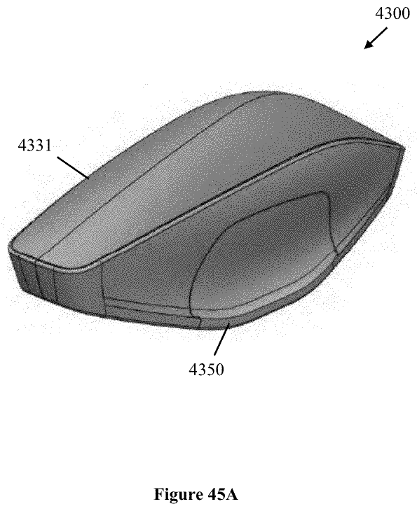

FIG. 44A shows another embodiment of a hand operated cutting tool 4200. Cutting tool comprises a cartridge 4250 that is removably coupled to a housing 4231. Cartridge 4250 comprises a cutting system 4201 having a first blade 4204 and a second blade 4255 disposed on a blade holder 4202 as shown in FIG. 44B. Blade holder 4201 further comprises a non-cutting surface 4224 that can be rotated against a surface to be cut to thereby position first blade 4204 or second blade 4255 to pierce and cut the surface. It is contemplated that first blade 4204, second blade 4255, blade holder 4202, and non-cutting surface 4224 could be identical in structure and function to those shown in cutting system 4101 (see, e.g., FIG. 43E). Additionally, it is contemplated that blade holder 4202 comprises one or more spring arms (e.g., spring arms as shown in FIG. 43E) to bias blade holder 4202 to a default position (e.g., the position shown in FIG. 44B), and one or more projections about which blade holder 4202 can rotate.

It should be noted that blade holder 4202 can rotate clockwise as cutting system 4201 is moved in a first direction (e.g., from left to right across a surface) or rotate counterclockwise as cutting system 4201 is moved in a second direction (e.g., from right to left across a surface) to position first blade 4204 or second blade 4255 to pierce and cut a surface in the same manner described and shown using blade holder 4102 with the exceptions being that (i) the one or more spring arms of blade holder 4202 push against an inner wall of cartridge 4250 to flex as opposed to an inner wall of a housing as described with the spring arms of blade holder 4102, and (ii) the projections of blade holder are rotatably coupled to cartridge 4250 as a pivot point for blade holder 4202 to rotate as opposed to the projections of blade holder 4102 that are disposed within an angled slot of a housing.

As described above, cartridge 4250 is removably coupled to housing 4231. Cartridge 4250 can be pushed in a downward direction 4254 into an opening 4252 of housing 4231 as shown in FIG. 44C to load cartridge 4250. It is contemplated that cartridge 4250 comprises an indentation 4256 that is sized and dimensioned to receive a projection within housing 4231. Once cartridge 4250 is installed, cutting tool 4200 could be moved across or along a surface to cut the surface. A user can push a top of cartridge 4250 in a downward direction 4258 to remove cartridge 4250 from housing 4231 as shown in FIG. 44D. Although FIGS. 44C-44D show cartridge 4250 inserted through a top of housing 4231 and removed through a bottom of housing 4231, it is contemplated that cartridge 4250 can be pushed in an upward direction through opening 4252 to insert cartridge 4250 through a bottom of housing 4231 and remove cartridge 4250 through a top of housing 4231.

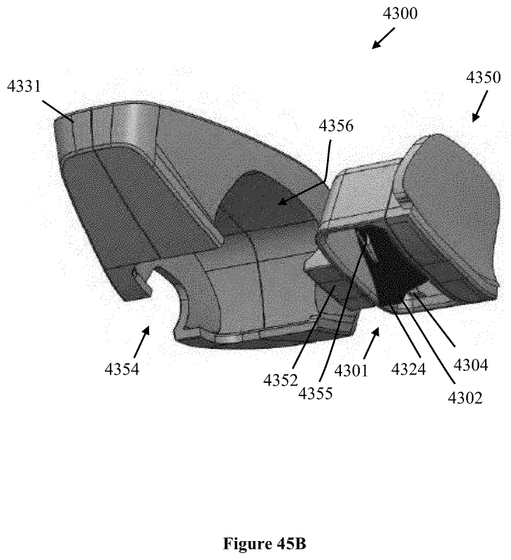

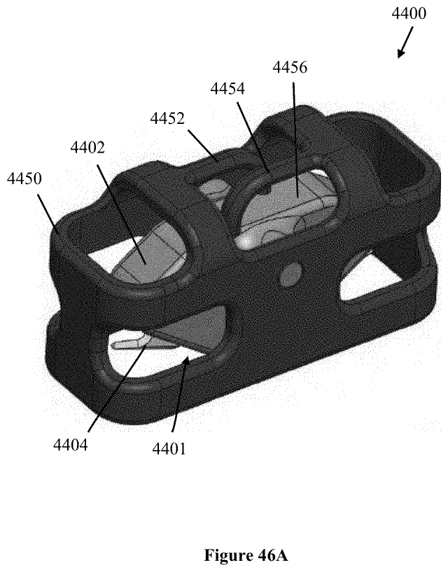

FIG. 45A shows another embodiment of a hand operated cutting tool 4300. Cutting tool comprises a cartridge 4350 that is removably coupled to a housing 4331. Cartridge 4350 comprises a cutting system 4301 having a first blade 4304 and a second blade 4355 disposed on a blade holder 4302 as shown in FIG. 45B. Blade holder 4302 further comprises a non-cutting surface 4324 that rotates against a surface to be cut to thereby position first blade 4304 or second blade 4355 to pierce and cut the surface. It is contemplated that first blade 4304, second blade 4355, blade holder 4302, and non-cutting surface 4324 could be identical in structure and function to those shown in cutting system 4101 (see, e.g., FIG. 43E). Additionally, it is contemplated that blade holder 4302 comprises one or more spring arms (e.g., spring arms as shown in FIG. 43E) to bias blade holder 4302 to a default position (e.g., the position shown in FIG. 45B), and one or more projections about which blade holder 4302 can rotate.

It should be noted that blade holder 4302 can rotate clockwise as cutting system 4301 is moved in a first direction (e.g., from left to right across a surface) or rotate counterclockwise as cutting system 4301 is moved in a second direction (e.g., from right to left across a surface) to position first blade 4304 or second blade 4355 to pierce and cut a surface in the same manner described and shown using blade holder 4102 with the exceptions being that (i) the one or more spring arms of blade holder 4302 push against an inner wall of cartridge 4350 to flex as opposed to an inner wall of a housing as described with the spring arms of blade holder 4102, and (ii) the projections of blade holder are rotatably coupled to cartridge 4350 as a pivot point for blade holder 4302 to rotate as opposed to the projections of blade holder 4102 that are disposed within an angled slot of a housing.

As described above, cartridge 4350 is removably coupled to housing 4331. Cartridge 4350 can be pushed in into an opening 4356 of housing 4331 to load cartridge 4350. It is contemplated that housing 4331 comprises a notch 4354 that is sized and dimensioned to receive a projection 4352 of cartridge 4352. Cartridge 4350 can be retained within housing 4331 through a friction fit between notch 4354 and projection 4352 or another removable fastener system (e.g., a recess or catch sized and dimensioned to receive a projection). Once cartridge 4350 is installed, cutting tool 4300 could be moved across or along a surface to cut the surface. A user can push against projection 4352 to remove cartridge 4350 from housing 4331 as shown in FIG. 45B.

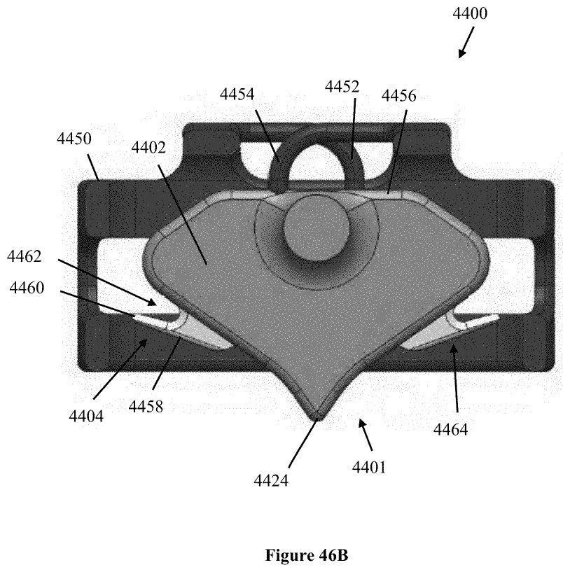

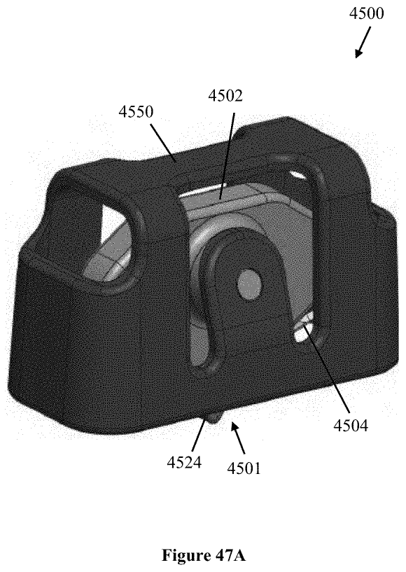

It is contemplated that many different cartridges can be installed in a cutting tool. One example is described above wherein a cartridge comprises a cutting system having a blade holder with one or more spring arms to bias the blade holder to a default position. FIGS. 46A-46B show a cartridge 4400 comprising a cutting system 4401 having a first blade 4404 disposed on a blade holder 4402. Cartridge 4400 comprises a housing 4450 that surrounds cutting system 4401. Housing 4450 comprises a first spring arm 4452 and a second spring arm 4454 that are disposed above a top surface 4456 of blade holder 4402.

Cutting system 4401 comprises a non-cutting surface 4424 that can be rotated against a surface to position a first blade 4404 to contact the surface with a non-cutting edge 4458, pierce the surface with a piercing edge 4460, and cut the surface with a cutting edge 4462. Additionally, non-cutting surface 4424 can be rotated against the surface to position a second blade 4464 to contact the surface with a non-cutting edge, pierce the surface with a piercing edge, and cut the surface with a cutting edge. Depending on the direction that blade holder 4424 rotates to position first blade 4404 or second blade 4464 to pierce and cut a surface, top surface 4456 pushes against first spring arm 4452 or second spring arm 4454 to flex first spring arm 4452 or second spring arm 4454. Once a cut is completed, first spring arm 4452 or second spring arm 4454 unflexes to thereby rotate blade holder 4402 to a default position (e.g., the position shown in FIG. 46B). Although two spring arms are shown FIGS. 46A-46B, it is contemplated that a single spring arm can be used. It is contemplated that cartridge 4400 can be used as a standalone unit or within a cutting tool (e.g., cutting tool 4200).

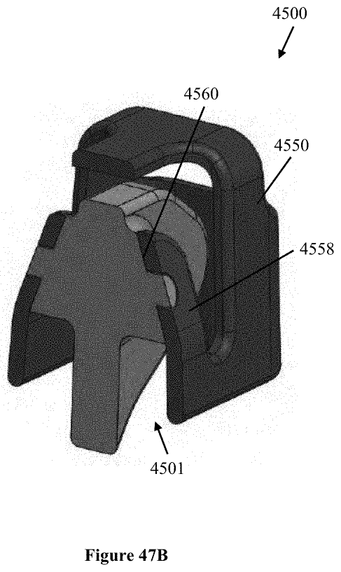

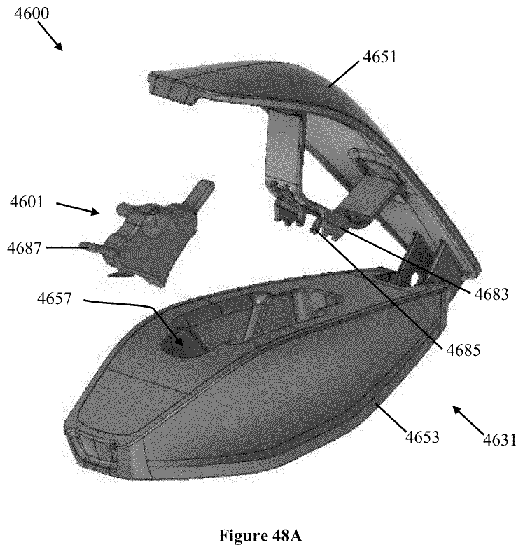

FIGS. 47A-47B show another embodiment of a cartridge 4500 comprising a cutting system 4501 having a blade 4504 disposed on a blade holder 4502. Cartridge 4500 comprises a housing 4550 that surrounds cutting system 4501. Similar to cutting system 4401 of cartridge 4400, it is contemplated that cutting system 4501 comprises a non-cutting surface 4524 that can be rotated against a surface to position blade 4504 to contact the surface with a non-cutting edge, pierce the surface with a piercing edge, and cut the surface with a cutting edge. Additionally, non-cutting surface 4524 can be rotated against the surface to position a second blade to contact the surface with a non-cutting edge, pierce the surface with a piercing edge, and cut the surface with a cutting edge.

As blade holder 4502 rotates to position blade 4504 or a second blade to pierce and cut a surface, an angled surface 4560 of blade holder 4502 rotates relative to an angled flap 4558 of housing 4550 to thereby flex the angled flap 4558. Once a cut is completed, angled flap 4558 unflexes to thereby rotate blade holder 4502 to a default position (e.g., the position shown in FIG. 47A). It is contemplated that cartridge 4500 can be used as a standalone unit or within a cutting tool (e.g., cutting tool 4200).

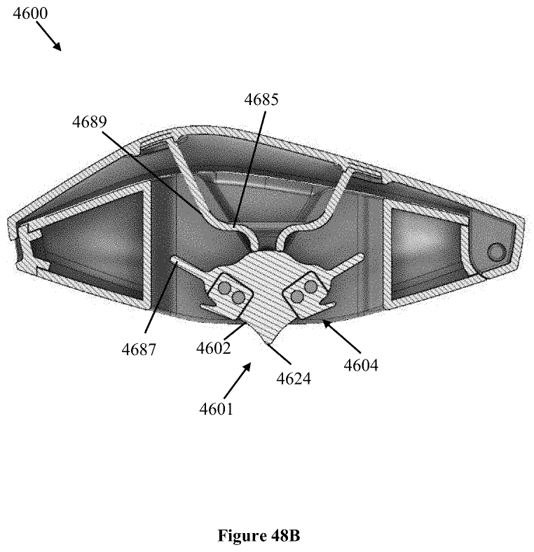

FIG. 48A shows another embodiment of a hand operated cutting tool 4600. Cutting tool 4600 comprises a housing 4631 having a top 4651 rotatably coupled to a bottom 4653. It is contemplated that cutting tool 4600 further comprises a cutting system 4601. Similar to cutting system 4101, cutting system 4601 comprises first and second blades disposed on blade holder that can be rotated to pierce and cut a surface when a non-cutting surface of the blade holder is rotated against the surface.

As shown in FIG. 48A, cutting system 4601 can be removed from housing 4631. A user can simply lift cutting system 4601 from within opening 4657. It is contemplated that a user can use a stop rib 4687 as a handle to pull cutting system 4601 from opening 4657. Top 4651 can have various surfaces that extend beneath a bottom surface of top 4651 to interact with cutting system 4601. For example, top 4651 can comprise a spring arm 4685 and a second spring arm that are disposed between a first protrusion 4683 and a second protrusion, whereby first protrusion 4683 and the second protrusion hold projections of the blade holder (similar to the manner described and shown in FIG. 43G) and spring arm 4685 and the second spring arm interact with cutting system 4601 as explained below.

FIG. 48B shows a cross-sectional view of cutting tool 4600. Cutting system 4601 comprises a first blade 4604 having a non-cutting edge, a piercing edge, and a cutting edge, and a second blade having a non-cutting edge, a piercing edge, and a cutting edge (see, e.g., first blade 4104 and second blade 4155 in FIG. 43E showing various features of the blade) that are mounted on a blade holder 4602. It is contemplated that cutting tool 4600 can be moved across or along a surface in a first direction (e.g., from left to right across the surface) or a second direction (e.g., from right to left across the surface) to create a cut. In other words, blade holder 4602 can rotate clockwise or counterclockwise as cutting system 4601 is moved across or along a surface to be cut to position either first blade 4604 or the second blade to pierce and cut the surface.

For example, cutting system 4601 can be (i) placed onto a surface, such that a non-cutting surface 4624 is in contact with the surface (see, e.g., left end of FIG. 43H), and (ii) moved across or along the surface in a first direction (e.g., from left to right across the surface) to thereby cause non-cutting surface 4624 and blade holder 4602 to rotate clockwise and position first blade 4604 to have the non-cutting edge contact the surface (see, e.g., second from the left end in FIG. 43H). As cutting system 4601 is further moved in the first direction, blade holder 4602 continues to rotate clockwise to position the piercing edge of first blade 4604 to pierce the surface (see, e.g., third from the left end in FIG. 43H), and is further rotated to thereby position the cutting edge of first blade 4604 to cut the surface (see, e.g., right end in FIG. 43H). Once the cutting edge of first blade 4604 is positioned to cut the surface, it is contemplated that further clockwise rotation is prevented due to stop rib 4687 of blade holder 4602 contacting an inner wall 4689 of housing 4631.

In such example, cutting system 4601 could be moved in a second direction across or along a surface (e.g., from right to left across the surface) to position the second blade to cut and pierce the surface. Cutting system 4601 can be placed onto a surface, such that non-cutting surface 4624 is in contact with the surface (see, e.g., right end of FIG. 43I), and moved across the surface in the second direction to cause non-cutting surface 4624 and blade holder 4602 to rotate counterclockwise and position the second blade to have the non-cutting edge contact the surface (see, e.g., second from the right end of FIG. 43I). As cutting system 4601 is further moved in the second direction, blade holder 4602 continues to rotate counterclockwise to position the piercing edge of the second blade to pierce the surface (see, e.g., third from the right end of FIG. 43I), and is further rotated to thereby position the cutting edge of the second blade to cut the surface (see left end in FIG. 43I). Once the cutting edge of the second blade is positioned to cut the surface, it is contemplated that further clockwise rotation is prevented due to a second stop rib of blade holder 4602 contacting an inner wall of housing 4631.

Once a cut is completed, a first spring arm 4685 or a second spring arm of housing 4631 can be used to bias blade holder 4602 to a default position (e.g., the position shown in FIG. 48B). For example, first spring arm 4685 or the second spring arm can flex when pressed against a top surface of blade holder 4602 as blade holder 4602 is rotated clockwise or counterclockwise from a default position (e.g., the position shown in FIG. 48B). As shown in FIG. 48B, first spring arm 4685 and the second spring arm can contact the top surface of blade holder 4602 when cutting system 4601 is disposed within housing 4631. As blade holder 4602 rotates clockwise, spring arm 4685 is pressed against a top surface of blade holder 4602 and is caused to flex. Once a cut is completed, spring arm 4685 unflexes to counterrotate blade holder 4602 to the default position (e.g., the position shown in FIG. 48B). Similarly, as blade holder 4602 rotates counterclockwise, the second spring arm is pressed against a top surface of blade holder 4602 and is caused to flex. Once a cut is completed, the second spring arm unflexes to counterrotate blade holder 4602 to the default position (e.g., the position shown in FIG. 48B).

It should be appreciated that contemplated cutting systems discussed herein can be incorporated into various cutting tools that are used to cut surfaces. It is contemplated that the blades and blade holders can be removably coupled, permanently coupled, or molded/formed to produce a single blade/blade holder unit. Additionally, the blade holder and/or blade of contemplated cutting systems can be removably coupled, permanently coupled, or can be molded/formed with other components of a cutting tool to produce a cutting tool. It is further contemplated that components of cutting tools can be removably coupled, permanently coupled, or molded to form a single unit. Additionally, although various embodiment describe a blade as having two piercing edges and cutting edges, it is contemplated that two blades can be used, such that a first blade having a piercing edge, non-cutting edge, and a cutting edge can be disposed on a blade holder and a second blade having a piercing edge, non-cutting edge, and a cutting edge can be disposed on the blade holder. Similarly, although various embodiments describe a cutting system as having first and second blades that each have a piercing edge and cutting edge, it is contemplated that a single blade can be used, such that the single blade can have two piercing edges and two cutting edges. As discussed above, cutting tools having contemplated cutting systems can be hand or machine operated.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A cutting system configured to pierce and cut a surface, comprising:
a blade holder;
a blade coupled to the blade holder;
a non-cutting surface;
wherein the blade comprises a first cutting edge and a first piercing edge; and
wherein, as the cutting system is moved across the surface in a first direction, the blade is configured to (i) pierce the surface with the first piercing edge when the non-cutting surface is rotated against the surface and the blade holder is rotated to a first rotated position, and (ii) cut the surface with the first cutting edge when the blade holder is further rotated from the first rotated position to a second rotated position.

2. The system of claim 1, wherein the blade comprises a first half and a second half, and wherein the first piercing edge is disposed in the first half, and the first cutting edge is disposed in the second half.

3. The system of claim 2, wherein the blade comprises a second cutting edge and a second piercing edge, and wherein the second cutting edge is disposed in the first half, and the second piercing edge is disposed in the second half.

4. The system of claim 3, wherein, as the cutting system is moved across the surface in a second direction, the blade is configured to (i) pierce the surface with the second piercing edge when the non-cutting surface is rotated against the surface and the blade holder is rotated to a third rotated position, and (ii) cut the surface with the second cutting edge when the blade holder is further rotated from the third rotated position to a fourth rotated position.

5. The system of claim 1, wherein the blade comprises a first half and a second half, and wherein the first piercing edge and the first cutting edge are disposed in the first half.

6. The system of claim 5, wherein the blade comprises a second cutting edge and a second piercing edge, and wherein the second cutting edge and the second piercing edge are disposed in the second half.

7. The system of claim 6, wherein, as the cutting system is moved across the surface in a second direction, the blade is configured to (i) pierce the surface with the second piercing edge when the non-cutting surface is rotated against the surface and the blade holder is rotated to a third rotated position, and (ii) cut the surface with the second cutting edge when the blade holder is further rotated from the third rotated position to a fourth rotated position.

8. The system of claim 1, wherein the non-cutting surface is disposed on the blade holder.

9. The system of claim 1, wherein the blade holder comprises a spring arm configured to bias the blade holder to a default position.

10. The system of claim 1, further comprising a blade guard having a flexible arm, wherein the blade guard is configured to cover the blade when the flexible arm is in a first position and uncover the blade when the flexible arm is in a second position.

11. The system of claim 10, wherein the non-cutting surface is disposed on the flexible arm, and further wherein the flexible arm is configured to bend from the first position to the second position when the non-cutting surface is rotated against the surface.

12. The system of claim 1, further comprising a blade guard configured to cover the blade in a first position and uncover the blade in a second position.

13. The system of claim 12, wherein the non-cutting surface is disposed on the blade guard, and further wherein the blade guard is configured to move from the first position to the second position when the curved non-cutting surface is rotated against the surface.

14. A cutting system for a cutting device to pierce and cut a surface, comprising:
a blade having a first cutting edge and a first piercing edge;
a non-cutting surface disposed on (i) a blade holder coupled to the blade or (ii) a blade guard configured to cover the blade; and
wherein the non-cutting surface is sized and dimensioned to position (i) the first piercing edge to pierce the surface when the non-cutting surface is rotated against the surface to a first rotated position, and (ii) the first cutting edge to cut the surface when the non-cutting surface is rotated against the surface from the first rotated position to a second rotated position.

15. The system of claim 14, wherein the blade comprises a non-cutting edge, and wherein the non-cutting surface is sized and dimensioned to position the non-cutting edge to contact the surface as the non-cutting surface is being rotated to the first rotated position.

16. The system of claim 14, wherein the blade comprises a first half and a second half, and wherein the first piercing edge and the first cutting edge are disposed in the first half.

17. The system of claim 14, wherein the blade holder is coupled to the blade, and further wherein the non-cutting surface is disposed on the blade holder.

18. The system of claim 14, wherein the blade guard is configured to cover the blade, and further wherein the non-cutting surface is disposed on the blade guard.

19. The system of claim 18, wherein the blade guard is configured to (i) cover the blade in a first position and (ii) uncover the blade in a second position, and further wherein the blade guard is configured to move from the first position to the second position when the non-cutting surface is rotated against the surface.

20. The system of claim 18, wherein the blade guard comprises a flexible arm configured to (i) position the blade guard to cover the blade when the flexible arm is in a first position, and (ii) position the blade guard to uncover the blade when the flexible arm is in a second position, and further wherein the non-cutting surface is disposed on the flexible arm, and the flexible arm is configured to bend from the first position to the second position when the curved surface is rotated against the surface.
